(19) United States
(12) Patent Application Publication
(10) Pub. No.: US 2012/0121858 A1
(43) Pub. Date: May 17, 2012

(54) HYDROPHOBIC FILM, PATTERNED FILM HAVING HYDROPHOBIC AND HYDROPHILIC REGIONS, AND METHOD FOR PRODUCING THE SAME

(75) Inventor: Shinji Kato, Sakura-shi (JP)

(73) Assignees: Kawamura Institue of Chemical Research, Sakura-shi (JP); DIC Corporation, Tokyo (JP)

(21) Appl. No.: 13/321,656

(22) PCT Filed: May 24, 2010
(86) PCT No.: PCT/JP2010/058708

§ 371 Date: Feb. 6, 2012

(30) Foreign Application Priority Data
May 25, 2009 (JP) 2009-125247
May 25, 2009 (JP) 2009-125248
Jan. 13, 2010 (JP) 2010-004864

(51) Int. Cl. C08J 3/28; C08F 22/10; B05D 3/06; C08F 120/36; C08F 22/20; B32B 3/10

(52) U.S. Cl. 428/141; 522/182; 427/487; 428/195.1; 526/320; 526/312; 526/321; 522/174

(57) ABSTRACT

The present invention relates to a method for producing a superhydrophobic film composed of a polymer having surface microstructures (irregularities) and in particular to a method for producing a superhydrophobic film that utilizes a phase separation phenomenon caused by a polymerization reaction by energy ray irradiation and to a superhydrophobic film formed by this production method. The method includes a step of preparing a film-forming composition (X) by mixing a polymerizable compound (A) that can be polymerized by energy ray irradiation and a compound (B) that is compatible with the polymerizable compound (A) but incompatible with a polymer of the polymerizable compound (A), a step of forming a layer of the film-forming composition (X); and a step of removing the compound (B) after polymerizing the polymerizable compound (A), in which the compound (B) is liquid or solid, has a molecular weight of 500 or less, and has a saturation vapor pressure of 400 Pa or less at 25° C.

### TECHNICAL FIELD

The present invention relates to a hydrophobic film and a method for producing the film. In particular, it relates to a hydrophobic film composed of a polymer having microstructures on a surface and a method for producing the film. The present invention also relates to a patterned film having a surface in which a hydrophobic region and a hydrophilic region co-exist (hydrophobic/hydrophilic patterned film), and a method for producing the film.

### BACKGROUND ART

In recent years, surfaces that strongly repel water (superhydrophobic surfaces) have drawn much attention. Although there is no scientific definition of a superhydrophobic surface, the word refers to a surface exhibiting a water contact angle of 150° or more which is significantly difficult to wet. Since the contact area between a superhydrophobic surface and water is significantly small, progress of various types of chemical reactions and formation of chemical bonds mediated by water can be suppressed. Accordingly, higher effects are expected for various purposes such as stain-proofing, rust proofing, prevention of snow and raindrop accretion, and electrical insulation compared to conventional hydrophobic surfaces (water contact angle of about 90 to 120°). The application range is wide, including surface coating materials for exteriors and interiors of housing equipment and automobiles, housing plumbing equipment such as kitchen, bathroom, and lavatories, electric appliances, leather products such as shoes and bags, clothing such as sporting clothing, medical equipment, dental equipment, outdoor equipment such as pylons, antennas, and wires, and household articles such as umbrellas, raincoats, helmets, paper, curtains, and carpets.

In the technical field of hydrophobic materials, a surface exhibiting a water contact angle of about 150° or more is called a superhydrophobic surface, a surface exhibiting a water contact angle of about 120 to 150° is referred to as a highly hydrophobic surface, and a surface exhibiting a water contact angle of about 90 to 120° is referred to as an ordinary hydrophobic surface.

A wetting phenomenon of a solid surface is determined by chemical properties and roughness (geometric form, topology) of the surface. Accordingly, a surface having a desired wetness can be obtained by masterly controlling the chemical properties and roughness. A superhydrophobic film can be realized by forming microstructures (irregularities) on a surface composed of a low-energy material. In order to obtain a superhydrophobic film, various techniques for forming surface microstructures have been taken. Among these, a technique that uses a phase separation phenomenon between substance, in particular, a phase separation phenomenon of polymers, is superior in terms of simplicity of production processes although there have been few such examples.

According to PTL 1, fine irregularities were formed in a film surface by coating a substrate surface with a polymer network structure in which a low-molecular-weight organic material is supported between three-dimensional continuous network skeletons composed of a thermoplastic elastomer material melted at a high temperature, cooling the coating film so as to form a polymer/low-molecular-weight material phase separation state, and removing the low-molecular-weight component by solvent extraction. The resulting film exhibited a water contact angle of 150° or more and was shown to serve as a superhydrophobic film.

In NPL 1, an isotactic polypropylene (i-PP) film having fine irregularities was formed by dissolving i-PP in a mixed solvent (containing a good solvent and a nonsolvent for i-PP), casting the resulting solution onto a substrate in a relatively high temperature state, and controlling the subsequent solvent evaporation process to induce a phase separation state. The water contact angle of this film was about 160°.

According to the two inventions described above, the phase separation state between the polymer material and the low-molecular-weight material or solvent is achieved by subjecting the mixture to a high-temperature state and thus relatively complicated operations are needed to obtain superhydrophobic films.

According to PTL 2 and NPL 2, a polymer film having fine irregularities was formed by coating a substrate surface with a composition containing a monomer that can be polymerized by energy ray irradiation, an oligomer or a polymer inactive to the energy ray, and a solvent, applying an energy ray to the coating to polymerize the monomer and to induce a phase separation state in a temperature range around room temperature, and removing the oligomer or polymer and the solvent therefrom. However, in these literatures, highly hydrophilic monomers are mainly used and these inventions are not intended to form superhydrophobic films.

Moreover, a compound having a hydroxyl group in a molecular terminus, such as a monoester of liquid polyethylene glycol or polyethylene glycol, is used as the oligomer inactive to the energy ray and removed after polymerization of the monomer. However, the inventor of the present application has confirmed that a polymer film that uses such a compound is a film that does not exhibit superhydrophobicity.

In PTL 3, a hydrophobic film is obtained by employing both ultraviolet curing and thermal curing of a coating film composed of a mixed coating material containing an acrylic UV-curable coating material, a wear-resistant thermally polymerizable silicone-based coating material, and a silane coupling agent containing fluorine. However, the water contact angle of the film surface is 98° at maximum and superhydrophobicity is not exhibited.

Hydrophobic/hydrophilic patterned surfaces including regions having different wettability from the surrounding regions formed on the same surface have been widely used in usages such as printing parts, display parts, transportation parts, and architectural decoration parts. In particular, many studies have been conducted for printing parts since, in printing characters, designs, and images, portions that receive the ink and portions that repel the ink during transfer of the printing ink are formed by a hydrophobic/hydrophilic pattern. However, in recent years, there has been a tendency to seek a superhydrophobic/hydrophilic patterned surface having superhydrophobic regions that highly repel water-based compositions so that a higher-resolution printing accuracy is realized in water-based printing. Moreover, a superhydrophobic/superhydrophilic patterned surface having superhydrophilic regions having a water contact angle of 10° or less as well as superhydrophobic regions are expected to be used in many usages other than printing parts, such as frost formation preventing parts, etc.

In PTL 4, a superhydrophobic film having a water contact angle of 150° or more was prepared by applying a sol-gel film precursor containing a photocatalyst inorganic coating material on a substrate subjected to a roughening treatment and heating the applied precursor to cause hydrolysis and polycondensation. Then the resulting film was patterned by exposure through a photomask to prepare a superhydrophobic/superhydrophilic patterned surface having superhydrophilic regions having a water contact angle of 10° or less.

In PTL 5, a superhydrophobic film having a water contact angle of 150° or more was prepared by treating an alumina film having fine irregularities obtained by a sol-gel reaction with a titanium oxide anatase sol and then a fluorine-containing silane compound. Then the resulting film was patterned by exposure through a photomask to prepare a superhydrophobic/superhydrophilic patterned surface having superhydrophilic regions having a water contact angle of 4° or less by the photocatalytic action of the titanium oxide crystal layer.

According to the two inventions described above, superhydrophilic regions have been patterned by using a photocatalytic action of a titanium oxide layer. However, it has been pointed out that organic matter that exists in the superhydrophobic regions will be gradually decomposed by the photocatalytic action and exhibit decreased hydrophobicity in long-term use.

### CITATION LIST

### Patent Literature

PTL 1: Japanese Unexamined Patent Application Publication No. 2005-53104
PTL 2: Japanese Unexamined Patent Application Publication No. 05-271460
PTL 3: Japanese Unexamined Patent Application Publication No. 08-169968
PTL 4: Japanese Unexamined Patent Application Publication No. 2000-87016
PTL 5: Japanese Unexamined Patent Application Publication No. 2001-17907

### Non Patent Literature

NPL 1: H. Y. Erbil et al., Science, 2003, 299, 1377-1380.
NPL 2: R. H. Schmidt et al., Chem. Mater., 2005, 17, 1007-1016.

### SUMMARY OF INVENTION

### Technical Problem

An object of the present invention is to provide a method for producing a hydrophobic film composed of a polymer having surface microstructures (irregularities), in particular, a superhydrophobic film having a water contact angle of 150° or more, and a superhydrophobic film formed by this method.

Another object of the present invention is to provide a method for producing a hydrophobic film through a simple room-temperature process by utilizing a phase separation phenomenon of a polymer induced by polymerization by energy ray irradiation, in particular, a superhydrophobic film having a water contact angle of 150° or more, and a superhydrophobic film formed by this method.

Yet another object of the present invention is to provide a method for producing a hydrophobic film, in particular, a superhydrophobic/hydrophilic patterned film having a surface in which hydrophilic regions and superhydrophobic regions having a water contact angle of 150° or more co-exist. In particular, the object is to provide a simple method for producing a superhydrophobic/superhydrophilic patterned film having superhydrophobic regions and superhydrophilic regions without using an action of a photocatalytic film, and a superhydrophobic/(super)hydrophilic patterned film formed by this method.

### Solution to Problem

The inventors of the present invention have conducted extensive studies and found that the objects can be achieved by forming, on a substrate, a layer of a film-forming composition which is a mixture of a polymerizable compound that can be polymerized by energy ray irradiation and an additive inactive to the energy ray, conducting polymerization by energy ray irradiation to induce a phase separation state, and then removing part of the soluble additive. Thus, the present invention has been made.

In other words, the present invention provides a method for producing a hydrophobic film. The method includes a step of preparing a film-forming composition (X) by mixing a polymerizable compound (A) that can be polymerized by energy ray irradiation and a compound (B) that is compatible with the polymerizable compound (A) but incompatible with a polymer (P_{A}) of the polymerizable compound (A) and that is inactive to an energy ray; a step of forming a layer of the film-forming composition (X); and a step of removing the compound (B) after polymerizing the polymerizable compound (A) in the film-forming composition (X) by irradiation of an energy ray. The compound (B) is liquid or solid, has a molecular weight of 500 or less, and has a saturation vapor pressure of 400 Pa or less at 25° C.

The present invention also provides a method for producing a patterned film having a hydrophobic region and a hydrophilic region in the same surface, the method including (1) step α1 including
preparing a film-forming composition (X) containing a polymerizable compound (A) that can be polymerized by energy ray irradiation and a compound (B) that is compatible with the polymerizable compound (A) but incompatible with a polymer (P_{A}) of the polymerizable compound (A) and that is inactive to an energy ray,
forming a layer of the film-forming composition (X), and
removing the compound (B) after polymerizing the polymerizable compound (A) in the film-forming composition (X) by irradiation of an energy ray to thereby form a hydrophobic film (SH); and

(2) step β2 including
preparing a polymerizable composition (Y) containing a polymerizable compound (E) that contains a hydrophilic chemical structural unit and that can be polymerized by energy ray irradiation,
applying the polymerizable composition (Y) to part or the entirety of a surface of the hydrophobic film (SH), and polymerizing the polymerizable compound (E) in the
polymerizable composition (Y) by energy ray irradiation,

The steps α1 and β2 are sequentially performed, and the compound (B) is liquid or solid, has a molecular weight of 500 or less, and has a saturation vapor pressure of 400 Pa or less at 25° C.

The present invention also provides a method for producing a patterned film having a hydrophobic region and a hydrophilic region in the same surface, the method including:

(1) step β1 including
preparing a polymerizable composition (Y) containing a polymerizable compound (E) that contains a hydrophilic chemical structural unit and that can be polymerized by energy ray irradiation,
forming a layer of the polymerizable composition (Y), and
polymerizing the polymerizable compound (E) in the polymerizable composition (Y) by energy ray irradiation to form a hydrophilic film (HP); and

(2) step α2 including
preparing a film-forming composition (X) by mixing a polymerizable compound (A) that can be polymerized by energy ray irradiation and a compound (B) that is compatible with the polymerizable compound (A) but incompatible with a polymer (P_{A}) of the polymerizable compound (A) and that is inactive to an energy ray,
applying the film-forming composition (X) to part or the entirety of a surface of the hydrophilic film (PH), and
performing pattern-irradiation with an energy ray so that the polymerizable compound (A) in the film-forming composition (X) is polymerized only in a portion irradiated with the energy ray and then removing the compound (B),

The steps β1 and α2 are sequentially performed, and the compound (B) is liquid or solid, has a molecular weight of 500 or less, and has a saturation vapor pressure of 400 Pa or less at 25° C.

The present invention also includes a hydrophobic film produced by a production method that includes a step of preparing a film-forming composition (X) by mixing a polymerizable compound (A) that can be polymerized by energy ray irradiation and a compound (B) that is compatible with the polymerizable compound (A) but incompatible with a polymer (P_{A}) of the polymerizable compound (A) and that is inactive to an energy ray; a step of forming a layer of the film-forming composition (X); and a step of removing the compound (B) after polymerizing the polymerizable compound (A) in the film-forming composition (X) by irradiation of an energy ray. The compound (B) is liquid or solid, has a molecular weight of 500 or less, and has a saturation vapor pressure of 400 Pa or less at 25° C.

The present invention further provides a hydrophobic film formed of a polymer of a polymerizable compound (A) that can be polymerized by energy ray irradiation, in which an average surface roughness (Ra) is in a range of more than 30 nm and up to 1000 nm.

### Advantageous Effects of Invention

According to the production method of the present invention, a hydrophobic film, in particular, a superhydrophobic film having a water contact angle of 150° or more, can be produced by a simple room-temperature process by curing a coating film composed of a film-forming composition containing a polymerizable compound through energy ray irradiation. This can be done without handling a resin melted at a high temperature as disclosed in PTL 1 and NPL 1.

Moreover, according to the production method of the present invention, a hydrophobic film, in particular, a superhydrophobic (water contact angle of 150° or more)/(super)hydrophilic patterned film can be produced by a simple process either by impregnating a porous polymer hydrophobic film having surface irregularities with a hydrophilic polymerizable composition and forming hydrophilic regions by energy ray irradiation, or by applying a polymerizable composition to a hydrophilic film surface composed of a polymer and forming hydrophobic regions having surface irregularities by energy ray irradiation. Thus, there is no need to use actions of photocatalysts disclosed in PTL 4 and PTL 5.

### BRIEF DESCRIPTION OF DRAWINGS

FIG. 1 is a photograph of a water drop on a surface of a superhydrophobic film [SH-1] obtained in Example 1.

FIG. 2 is a scanning electron microscope image of a surface of a superhydrophobic film [SH-1] obtained in Example 1.

FIG. 3 is a photograph of a water drop on a surface of a superhydrophobic film [SH-2] obtained in Example 2.

FIG. 4 is a scanning electron microscope image of a surface of a superhydrophobic film [SH-2] obtained in Example 2.

FIG. 5 is a photograph of a water drop on a surface of a superhydrophobic film [SH-3] obtained in Example 3.

FIG. 6 is a scanning electron microscope image of a surface of a superhydrophobic film [SH-3] obtained in Example 3.

FIG. 7 is a photograph of a water drop on a surface of a superhydrophobic film [SH-4] obtained in Example 4.

FIG. 8 is a scanning electron microscope image of a surface of a superhydrophobic film [SH-4] obtained in Example 4.

FIG. 9 is a photograph of a water drop on a surface of a superhydrophobic film [SH-5] obtained in Example 5.

FIG. 10 is a scanning electron microscope image of a surface of a superhydrophobic film [SH-5] obtained in Example 5.

FIG. 11 is a photograph of a water drop on a surface of a superhydrophobic film [SH-6] obtained in Example 6.

FIG. 12 is a scanning electron microscope image of a surface of a superhydrophobic film [SH-6] obtained in Example 6.

FIG. 13 is an atomic force microscope profile of a surface of a superhydrophobic film [SH-6] obtained in Example 6.

FIG. 14 is a photograph of a water drop on a surface of a superhydrophobic film [SH-18] obtained in Example 18.

FIG. 15 is a scanning electron microscope image of a surface of a superhydrophobic film [SH-18] obtained in Example 18.

FIG. 16 is an atomic force microscope profile of a surface of a superhydrophobic film [SH-18] obtained in Example 18.

FIG. 17 is a photograph of a water drop on a surface of a superhydrophobic film [SH-20] obtained in Example 20.

FIG. 18 is a scanning electron microscope image of a surface of a superhydrophobic film [SH-20] obtained in Example 20.

FIG. 19 is an atomic force microscope profile of a surface of a superhydrophobic film [SH-20] obtained in Example 20.

FIG. 20 is a photograph of the appearance of a superhydrophobic/hydrophilic patterned film [SHL-1] obtained in Example 24.

FIG. 21 is a scanning electron microscope image of a superhydrophobic part of a superhydrophobic/hydrophilic patterned film [SHL-1] obtained in Example 24.

FIG. 22 is a scanning electron microscope image of the border between a superhydrophobic portion and a hydrophilic portion of a superhydrophobic/hydrophilic patterned film [SHL-1] obtained in Example 24, and the nearby region.

FIG. 23 is a photograph of the appearance of a superhydrophobic/hydrophilic patterned film [SHL-18] obtained in Example 41.

FIG. 24 is a scanning electron microscope image of a superhydrophobic part of a superhydrophobic/hydrophilic patterned film [SHL-18] obtained in Example 41.

FIG. 25 is a scanning electron microscope image of a superhydrophilic part of a superhydrophobic/hydrophilic patterned film [SHL-18] obtained in Example 41.

FIG. 26 is a scanning electron microscope image of an film [R-7] cured by irradiation of an energy ray obtained in Comparative Example 7.

### DESCRIPTION OF EMBODIMENTS

The present invention is described below.

In general, in the technical field of hydrophobic materials, a surface exhibiting a water contact angle of about 150° or more is called a superhydrophobic surface and a surface exhibiting a water contact angle of about 120 to 150° is called a highly hydrophobic surface to distinguish from an ordinary hydrophobic surface exhibiting a water contact angle of about 90 to 120°, although there is no clear distinction or definition academically or technically.

In this description, the general distinctions described above are employed. That is, a surface exhibiting a water contact angle of about 150° or more is defined to be a “superhydrophobic” surface, a surface exhibiting a water contact angle of about 120° or more and less than 150° is defined to be a “highly hydrophobic” surface, and a surface exhibiting a water contact angle of about 90° to less than 120° is defined to be an “ordinary hydrophobic” surface. However, a simple notation “hydrophobic surface” is to cover all of the “superhydrophobic surface”, the “highly hydrophobic surface” and the “ordinary hydrophobic surface”.

According to the production method of the present invention, production of the films having “superhydrophobic”, “highly hydrophobic”, and “ordinary hydrophobic” surfaces can be controlled by selecting raw materials, adjusting the blend amount, adjusting film-forming conditions, etc. However, the production method of the present invention is particularly suitable for producing films having “superhydrophobic” and “highly hydrophobic” surfaces and is most suitable for producing films having “superhydrophobic” surfaces. Accordingly, the description below mainly focuses on a method for producing a film having a superhydrophobic surface.

There is no clear distinction or definition academically or technically for superhydrophilicity. In general, a surface exhibiting a water contact angle of about 10° or less is called a superhydrophilic surface.

In this description, a surface exhibiting a water contact angle of 10° or less is defined to be a “superhydrophilic surface”. However, a simple notation “hydrophilic surface” means a general hydrophilic surface including a “superhydrophilic surface”.

### <Basic Invention>

A superhydrophobic film of the present invention can be produced by forming a thin layer of a film-forming composition (X) prepared by mixing a polymerizable compound (A) that can be polymerized by energy ray irradiation and a compound (B) that is compatible with the polymerizable compound (A) but incompatible with a polymer (P_{A}) obtained from the polymerizable compound (A) and that is inactive to the energy ray, conducting polymerization by energy ran irradiation, and removing the compound (B).

According to this method, the polymer (P_{A}) produced by polymerization of the polymerizable compound (A) is incompatible with the compound (B), and a phase separation state is created between the polymer (P_{A}) and the compound (B) where the compound (B) is trapped in the polymer (P_{A}) or between the molecules of the polymer (P_{A}). Removing the compound (B) generates pores in regions previously occupied by the compound (B) to generate fine irregularities on the film surface, and thus a superhydrophobic film can be formed.

For the polymerizable compound (A), a polymerizable compound (a) that can be polymerized by energy ray irradiation can be used alone or two or more types of such a compound may be used in combination. The polymerizable compound (a) may be any material that can be polymerized by irradiation with an energy ray to give a polymer, and may be a radically polymerizable compound, an anionically polymerizable compound, a cationically polymerizable compound, or the like. For example, a polymerizable compound containing a vinyl group is used. In particular, a (meth)acrylic compound that exhibits high polymerization rate by irradiation with an energy ray is preferred. Moreover, a compound gives a crosslinked polymer by polymerization is preferred since the strength after curing is high and a difunctional or higher functional polymerizable compound having two or more vinyl groups in a molecule is particularly preferred.

Examples of the (meth)acrylic compound include difunctional monomers such as ethylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethyloltricyclodecane di(meth)acrylate, diethylene glycol di(meth)acrylate, triethylene glycol di(meth)acrylate, glycerol di(meth)acrylate, 2-isocyanato-2-methylpropyl di(meth)acrylate, 2-methacryloyloxyethyl acid phosphate, 3-methyl-1,5-pentanediol di(meth)acrylate, 2-butyl-2-ethyl-1,3-propanediol di(meth)acrylate, 2,2′-bis(4-(meth)acryloyloxy polyethyleneoxy phenyl)propane, 2,2′-bis(4-(meth)acryloyloxy polypropyleneoxy phenyl)propane, hydroxy dipivalic acid neopentyl glycol di(meth)acrylate, dicyclopentanyl diacrylate, bis(acroxyethyl)hydroxyethyl isocyanurate, and N-methylenebisacrylamide; trifunctional monomers such as trimethylolpropane tri(meth)acrylate, trimethylolethane tri(meth)acrylate, pentaerythritol tri(meth)acrylate, tris(acroxyethyl) isocyanurate, and caprolactone-modified tris(acroxyethyl) isocyanurate; tetrafunctional monomers such as pentaerythritol tetra(meth)acrylate; and hexafunctional monomers such as dipentaerythritol hexa(meth)acrylate.

Examples of the polymerizable oligomer having a (meth)acryloyl group in a molecular chain include oligomers having a weight-average molecular weight of 500 to 50,000, e.g., (meth)acrylic esters of epoxy resins, (meth)acrylic esters of polyether resins, (meth)acrylic esters of polyether resins having a bisphenol A skeleton, (meth)acrylic esters of polybutadiene resins, (meth)acrylic esters of polydimethylsiloxane resins, and polyurethane resins having a (meth)acryloyl group in a molecular terminus.

Of the polymerizable compounds and the polymerizable oligomers listed above, ethylene glycol di(meth)acrylate, 1,4-butanediol di(meth)acrylate, 1,6-hexanediol di(meth)acrylate, neopentyl glycol di(meth)acrylate, dimethyloltricyclodecane di(meth)acrylate, and trimethylolpropane tri(meth)acrylate are preferred since these tend to give polymer films having high hydrophobicity, a high crosslinking density after polymerization, and developed surface microstructures.

A monofunctional polymerizable compound having one vinyl group, in particular, a (meth)acrylic compound having one vinyl group, can be used as the polymerizable compound (a). However, the monofunctional polymerizable compound is preferably used in combination with a difunctional or higher functional polymerizable compound.

Examples of the (meth)acrylic compound having one vinyl group include methyl (meth)acrylate, alkyl (meth)acrylate, isobornyl(meth)acrylate, alkoxy polyethylene glycol (meth)acrylate, phenoxy dialkyl (meth)acrylate, phenoxypolyethylene glycol (meth)acrylate, alkyl phenoxy polyethylene glycol (meth)acrylate, nonylphenoxy polypropylene glycol (meth)acrylate, hydroxyalkyl (meth)acrylate, glycerol acrylate methacrylate, butanediol mono(meth)acrylate, 2-hydroxy-3-phenoxy propyl acrylate, 2-acryloyloxyethyl-2-hydroxypropyl acrylate, ethylene oxide-modified phthalic acid acrylate, ω-carboxycaprolactone monoacrylate, 2-acryloyloxy propyl hydrogen phthalate, 2-acryloyloxy ethyl succinic acid, acrylic acid dimer, 2-acryloyloxypropyl hexahydrohydrogen phthalate, fluorine-substituted alkyl (meth)acrylate, chlorine-substituted alkyl (meth)acrylate, sulfonic acid soda ethoxy (meth)acrylate, sulfonic acid-2-methylpropane-2-acrylamide, phosphoric ester group-containing (meth)acrylate, glycidyl (meth)acrylate, 2-isocyanatoethyl (meth)acrylate, (meth)acryloyl chloride, (meth)acrylic aldehyde, sulfonic acid ester group-containing (meth)acrylate, silano group-containing (meth)acrylate, ((di)alkyl)amino group-containing (meth)acrylate, quaternary ((di)alkyl)ammonium group-containing (meth)acrylate, (n-alkyl)acrylamide, (N,N-dialkyl)acrylamide, acryloyl morpholine, and polydimethylsiloxane chain-containing (meth)acrylate.

Among these monofunctional polymerizable compounds, methyl (meth)acrylate, alkyl (meth)acrylate, and isobornyl (meth)acrylate are preferably used to enhance the hydrophobicity and adjust the viscosity, and fluorine-substituted alkyl (meth)acrylate and polydimethylsiloxane chain-containing (meth)acrylate are preferably used to decrease the free energy of the surface by localization in the film surface after polymerization.

For the compound (B), compounds (b) described below can be used alone or two or more types of the compounds may be used in combination. The compound (b) remains on a substrate during a polymerization process of the polymerizable compound (A) and is removed mainly by washing with a solvent after the polymerization. The compound (b) which is a constitutional component of the compound (B) is not particularly limited as long as it is a liquid or solid compound that is compatible with the polymerizable compound (A) but incompatible with the polymer (P_{A}) of the polymerizable compound (A), is inactive to the energy ray, and has a molecular weight of 500 or less and a saturation vapor pressure at 25° C. of 400 Pa or less. The molecular weight is more preferably 300 or less. The compound (b) is preferably a compound having high hydrophobicity since the compound is present near the surface once a phase separation state is created with the polymer (P_{A}), helps form fine irregularities on the film surface after removal, and thus facilitates formation of a superhydrophobic film. Accordingly, the compound (b) is preferably a compound that does not contain a polar chemical unit such as a hydroxyl group, an amino group, a carboxy group, an isocyanate group, a mercapto group, a cyano group, an amide bond, a urea bond, etc.

Examples of the compound that satisfies this requirement and has high hydrophobicity include compounds (b) which are represented by formula (1), formula (2), formula (3), and formula (4) below, and alkanes having 10 to 20 carbon atoms which may be branched.

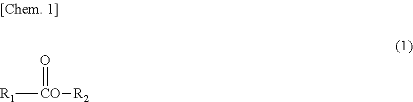

(In formula (1), R₁ represents an alkyl group having 9 to 19 carbon atoms which may be branched or a benzyl group, and R₂ represents a methyl group or an ethyl group.)

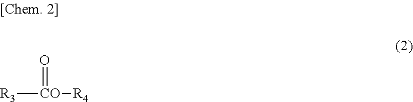

(In formula (2), R₃ represents a methyl group or an ethyl group, and R₄ represents an alkyl group having 10 to 20 carbon atoms which may be branched or a benzyl group.)

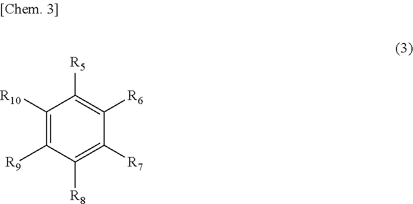

(In formula (3), R₅ to R₁₀ each independently represent a hydrogen atom or an alkyl group which may be branched and at least two of R₅ to R₁₀ are ethyl groups or at least one of R₅ to R₁₀ is an alkyl group having 3 to 8 carbon atoms which may be branched.)

[Chem. 4]

R₁₁—O(CH₂)₂O(CH₂)₂O—R₁₂ (4)

(In formula (4), R₁₁ and R₁₂ each independently represent an alkyl group having 2 to 8 carbon atoms which may be branched.)

In formulae (1) and (2), R₁ and R₄ each preferably represent an alkyl group having 7 to 18 carbon atoms and more preferably an alkyl group having 8 to 16 carbon atoms. In formula (3), at least one of R₅ to R₁₀ preferably represents an alkyl group having 3 to 7 carbon atoms and more preferably an alkyl group having 3 to 6 carbon atoms. In such a case, the remaining groups are preferably each a hydrogen atom. The total number of carbon atoms in R₅ to R₁₀ is preferably 10 or less. In formula (4), R₁₁ and R₁₂ each preferably independently represent an alkyl group having 2 to 7 carbon atoms and more preferably an alkyl group having 2 to 6 carbon atoms. The alkane is preferably an alkane having 12 to 20 carbon atoms and more preferably 12 to 18 carbon atoms.

Among these, when a liquid or solid having a saturation vapor pressure of 150 Pa or more at 25° C. is used, a thinner film can be formed due to low volatility. Thus, this is advantageous in preparing a highly transparent superhydrophobic film. Examples of such a compound include methyl esters of long-chain aliphatic carboxylic acids such as methyl tetradecanoate, methyl hexadecanoate, methyl octadecanoate, and long-chain aliphatic hydrocarbons such as tetradecane, hexadecane, and octadecane.

The contents of the polymerizable compound (A) and the compound (B) in the film-forming composition (X) affect the pore size of the superhydrophobic film, surface irregularities, and strength. When the polymerizable compound (A) content is high, the strength of the film is improved but the pore size inside the film and the surface irregularities are reduced and the hydrophobicity tends to be low. The content of the polymerizable compound (A) is preferably in the range of 30 to 80% by mass and more preferably in the range of 40 to 70% by mass. When the polymerizable compound (A) content is 30% by mass or less, the strength of the film is lowered. When the polymerizable compound (A) content is 80% by mass or more, the pore size inside the film and the surface irregularities are difficult to control.

The film-forming composition (X) may contain a highly volatile liquid compound (D) as a constitutional component together with the compound (b) described above since this is effective for decreasing the thickness of the superhydrophobic film to be prepared and increasing the transparency of the film. In such a case, after application of the film-forming composition to a substrate, the compound (b) remains on the substrate during the polymerization process of the polymerizable compound (A) but the compound (D) is evaporated. Thus, the thickness is reduced. The compound (D) is preferably a liquid having a saturation vapor pressure of 600 Pa or more at 25° C. Preferable examples of the compound that satisfies such a requirement and has high hydrophobicity include pentane, hexane, heptane, R₁₃COOR₁₄ (where R₁₃ and R₁₄ each independently represent an alkyl group having 1 to 5 carbon atoms and the total number of carbon atoms in R₁₃ and R₁₄ is 6 or less), R₁₅COR₁₆ (where R₁₅ and R₁₆ each independently represent an alkyl group having 1 to 5 carbon atoms and the total number of carbon atoms in R₁₅ and R₁₆ is 6 or less), R₁₇OR₁₈ (where R₁₇ and R₁₈ each independently represent an alkyl group having 1 to 6 carbon atoms and the total number of carbon atoms in R₁₇ and R₁₈ is 7 or less), benzene, toluene, dichloromethane, chloroform, and carbon tetrachloride. Specific examples of R₁₃COOR₁₄ include ethyl acetate, methyl propionate, ethyl propionate, methyl butanoate, ethyl butanoate, methyl pentanoate, ethyl pentanoate, and methyl hexanoate. Specific examples of R₁₅COR₁₆ include acetone, methyl ethyl ketone, and methyl isobutyl ketone. Specific examples of R₁₇OR₁₈ include diethyl ether. The mixing ratio of the compound (b) to the compound (D) may be adequately set according to the desired performance of the superhydrophobic film, in particular, transparency.

To the film-forming composition (X), various additives, such as a polymerization initiator, a polymerization inhibitor, a polymerization delaying agent, and a thickener, may be added to adjust the polymerization rate, the degree of polymerization, the pore size of the film, surface irregularities, etc.

The polymerization initiator may be any material that can cause the polymerizable compound (A) to be polymerized by energy ray irradiation, and may be a radical polymerization initiator, an anionic polymerization initiator, a cationic polymerization initiator, or the like. Examples thereof include acetophenones such as p-tert-butyltrichloroacetophenone, 2,2′-diethoxyacetophenone, and 2-hydroxy-2-methyl-1-phenylpropan-1-one; ketones such as benzophenone, 4,4′-bisdimethylaminobenzophenone, 2-chlorothioxanthone, 2-methylthioxanthone, 2-ethylthioxanthone, and 2-isopropylthioxanthone; benzoin ethers such as benzoin, benzoin methyl ether, benzoin isopropyl ether, and benzoin isobutyl ether; benzyl ketals such as benzyl dimethyl ketal and hydroxycyclohexyl phenyl ketone; and azides such as N-azidosulfonylphenyl maleimide. A polymerizable photopolymerization initiator such as a maleimide-based compound can also be used. These polymerization initiators may be used in combination with a disulfide compound such as tetraethylthiuram disulfide, a nitroxide compound such as 2,2,6,6-tetramethylpiperidine 1-oxyl, a 4,4′-di-t-butyl-2,2′-bipyridine copper complex-methyl trichloroacetate composite, and benzyl diethyl dithiocarbamate so that the polymerization initiator can be used as a living radical polymerization initiator.

Examples of the polymerization delaying agent and the polymerization inhibitor include vinyl monomers having a low polymerization rate, such as α-methylstyrene, 2,4-diphenyl-4-methyl-1-pentene, etc., and hindered phenols such as tert-butylphenol.

A common known thickener may be used as the thickener to improve the coatability, the evenness of the film thickness and control the pore size inside the film and the surface irregularities. When the film-forming composition (X) has a low viscosity, the shape of the pores is frequently determined by gaps between the polymer particles bonded to each other. When the viscosity is high, the shape is frequently determined by gaps between molecules of polymers that have precipitated to form a network structure. In other words, although the coatability and the evenness of the film thickness improve as the viscosity increases, the pore size and the surface irregularities become smaller and finer and thus the hydrophobicity tends to decrease. Thus, it is critical to adequately change the viscosity according to the combination of the materials constituting the film-forming composition (X) and the desired performance of the film.

The hydrophobic film of the present invention may be a self-supporting film constituted by the film alone or may be a multilayer product with the film stacked on a substrate (S). The substrate (S) onto which the hydrophobic film of the present invention is stacked may be any substrate that is not substantially impaired by the film-forming composition (X) or the energy ray used, i.e., that does not undergo dissolution, decomposition, polymerization, etc., and that does not substantially invade the film-forming composition (X). Examples of such a substrate include resins, glass, crystals such as quartz, ceramics, semiconductors such as silicon, metals, and metal oxides. Among these, resins and glass are preferred since they have high transparency and are inexpensive. The resin used in the substrate may be a homopolymer composed of a single monomer or a copolymer composed of a plurality of types of monomers, and may be a thermoplastic polymer or a thermosetting polymer. The substrate may be constituted by a polymer blend or a polymer alloy, and may be a laminate or other compound material. The substrate may further contain additives such as a modifier, a colorant, a filler, and a reinforcement.

The shape of the substrate is not particularly limited and may be any shape that suits the purpose of use. Examples of the shape include a sheet shape (including a film shape, a ribbon shape, and a belt shape), a plate shape, a roll shape, and a spherical shape. From the viewpoint of ease of applying the film-forming composition (X) thereon and ease of applying the energy ray, the surface on which the composition is applied is preferably flat or two-dimensionally curved.

The substrate may be surface-treated irrespective of whether it is composed of a resin or other materials. Examples of the surface treatment include a treatment aimed to prevent dissolution of the substrate with the film-forming composition (X) and a treatment aimed to improve the wettability of the film-forming composition (X) and the adhesion of the superhydrophobic film.

The surface treatment method for the substrate may be any. Examples thereof include a treatment of applying the polymerizable compound (A) to a surface of a substrate and irradiating the applied compound with an energy ray to conduct curing, a corona treatment, a plasma treatment, a flame treatment, an acid or alkali treatment, a sulfonating treatment, a fluorinating treatment, a primer treatment using a silane coupling agent or the like, a surface graft polymerization, application of a surfactant, a releasing agent, or the like, and a physical treatment such as rubbing and sand blasting. Another example is a method with which a compound to be immobilized on a surface is reacted with a functional group of the superhydrophobic film or a functional group introduced by the above-described surface treatment method. When glass or quartz is used as the substrate among these materials, a method of treating with a silane coupling agent such as trimethoxysilylpropyl (meth)acrylate or a triethoxysilylpropyl (meth)acrylate is useful since polymerizable groups of the silane coupling agent can be copolymerized with the film-forming composition (X) and thus the adhesion of the superhydrophobic film to the substrate can be improved.

The method for applying the film-forming composition (X) to the substrate may be any common known method. Preferable examples thereof include a dipping method, a roll coating method, a doctor blade method, a spin coating method, and a spraying method.

Examples of the energy ray applied during the polymerization process include light such as ultraviolet rays, visible light rays, infrared rays, laser beams, and radiant light; ionizing irradiation such as X-rays, gamma rays, and radiant light; and particle beams such as electrons, ion beams, beta rays, and heavy particle beams. Of these, ultraviolet rays and visible light rays are preferred from the viewpoint of handling ease and curing rate. Ultraviolet rays are particularly preferable. In order to increase the curing rate and completely carry out curing, energy ray irradiation is preferably conducted in a low-oxygen-concentration atmosphere. The low-oxygen-concentration atmosphere is preferably a nitrogen stream, a carbon dioxide stream, an argon stream, vacuum, or a reduced-pressure atmosphere.

Removal of the compound (B) from the film in which the phases of the compound (B) and the polymer (P_{A}), which is produced by polymerization of the film-forming composition (X), are separated can be carried out by washing with a solvent. During this process, the regions occupied by the compound (B) are substituted with the solvent and the solvent is evaporated in the subsequent drying process so as to form pores inside the film and irregularities in the surface, thereby ending the production of the superhydrophobic film. The solvent may be any solvent that is compatible with the compound (b). However, in order to simplify the drying operation, it is preferable to use a highly volatile general-purpose solvent such as methanol, ethanol, acetone, hexane, ethyl acetate, diethyl ether, and chloroform.

The superhydrophobic film produced by the method of the present invention is a porous film having an aggregated particle structure in which polymer particles about 0.05 μm to 10 μm in diameter are aggregated and gaps between the particles form pores or a porous film having a three-dimensional network structure in which the polymer molecules are aggregated into a network structure. The average surface roughness (Ra) of the resulting superhydrophobic film is more than 30 nm and up to 1000 nm. The average surface roughness (Ra) of the superhydrophobic film is preferably 40 to 1000 nm and more preferably 40 to 500 nm. The surface exhibits a water contact angle of 150° or more when the surface roughness is within this range.

Note that the average surface roughness (Ra) described above is the value measured with an instrument (I) below and the average surface roughness (Ra) described in Claims is the value measured with the instrument (I).

Instrument (I): scanning probe microscope (SPI3800N/SPA400): produced by SII NanoTechnology Inc.

Measurement mode: AFM

Scanning area: 10 μm×10 μm

The data measured with an instrument (II) below that measures the average surface roughness based on the same principle as with the measuring instrument above are also described in Examples below for reference.

Instrument (II): Nanoscale Hybrid Microscope VN-8000 produced by KEYENCE CORPORATION

Measurement mode: AFM

Scanning area: 10 μm×10 μm

When measurement is conducted with the instrument (II), the average surface roughness (Ra) of the superhydrophobic film obtained by the production method of the present invention is in the range of 20 to 1000 nm due to slight machine difference.

According to the production method of the present invention, a highly transparent superhydrophobic film can be obtained as described above. For example, a transparent superhydrophobic film having a transmittance of 80% or more for visible light having a wavelength of 600 nm has a thickness in the range of 0.02 to 1.00 μm and an average surface roughness (Ra) exceeding 30 and up to 100 nm. The average surface roughness (Ra) is preferably in the range of 40 to 100 nm.

A superhydrophobic film having high durability can be obtained by repeating the steps of the production method of the present invention. In this case, as the layers are stacked, pores in the underlying layers are partially filled with the polymer constituting the overlying layers. Thus, the structure is reinforced and the chance stability of the film and the wear resistance of the surface are improved as a result.

### <Invention Regarding a Film-Forming Composition (X) Containing a Polymer (C)>

The film-forming composition (X) may further contain a polymer (C) which is compatible with the polymerizable compound (A) and the compound (B) and is inactive to the energy ray.

In this case, the polymer (P_{A}) produced by polymerization of the polymerizable compound (A) is incompatible with the compound (B), a phase separation state is created between the polymer (P_{A}) and the compound (B), and the compound (B) is trapped in the polymer (P_{A}) or between the molecules of the polymer (P_{A}). Removing the compound (B) generates pores in regions previously occupied by the compound (B) to generate irregularities on the film surface, and thus a superhydrophobic film can be formed. All of the polymer (C) may be removed from the cured film of the film-forming composition (X) as long as the effects of the present invention are not impaired; however, at least part of the polymer (C) preferably remains in the cured film in order to ensure the strength of the cured film. Thus, the polymer (C) is preferably distributed in the polymer (P_{A}) phase to a particular degree among the polymer (P_{A}) and the compound (B) in a phase separation state. The higher the distribution ratio, the higher the strength of the cured film.

For the compound (C), a polymer can be used alone or two or more types of polymers may be used in combination. The constitutional component of the polymer (C) is not particularly limited as long as it is compatible with the polymerizable compound (A) and the compound (B) and is inactive to the energy ray. All of the polymer (C) may be removed from the cured film of the film-forming composition (X) as long as the effects of the present invention are not impaired; however, at least part of the polymer (C) preferably remains in the cured film in order to ensure the strength of the cured film. Thus, the polymer (C) is preferably distributed in the polymer (P_{A}) phase to a particular degree among the polymer (P_{A}) and the compound (B) in a phase separation state. The higher the distribution ratio, the higher the strength of the cured film. From this viewpoint, the polymer (C) preferably has high hydrophobicity in order to function as a component constituting the superhydrophobic film. An acrylic (co)polymer or a styrene (co)polymer is preferably used. In particular, polymethyl (meth)acrylate, polyethyl (meth)acrylate, polyisopropyl (meth)acrylate, polybutyl (meth)acrylate, polyisobutyl (meth)acrylate, poly-tert-butyl (meth)acrylate, polyhexyl (meth)acrylate, polydodecyl (meth)acrylate, polystearyl (meth)acrylate, polyisobornyl (meth)acrylate, polystyrene, or poly α-methylstyrene is preferably used. One of the roles of the polymer (C) is to expand the phase separation conditions by increasing the viscosity of the film-forming composition (X). In particular, when the viscosity of the film-forming composition (X) is high, the number of the types of the polymerizable compound (A) and the compound (B) that can be used in the composition is increased. Moreover, as described below, the viscosity of the film-forming composition (X) affects the pore size and the surface irregularities of the superhydrophobic film. Accordingly, it is critical that the molecular weight of the polymer be adequately set according to the purpose and performance of the superhydrophobic film. The molecular weight of the polymer is preferably set in the range of 10,000 to 1,000,000.

The relative contents of the polymerizable compound (A), the compound (B), and the polymer (C) in the film-forming composition (X) affect the pore size of the superhydrophobic film, surface irregularities, and strength. When the polymerizable compound (A) content is high, the strength of the film is improved but the pore size inside the film and the surface irregularities are reduced and the hydrophobicity tends to be low. The content of the polymerizable compound (A) is preferably in the range of 30 to 80% by mass and more preferably in the range of 40 to 70% by mass. When the polymerizable compound (A) content is 30% by mass or less, the strength of the film is lowered. When the polymerizable compound (A) content is 80% by mass or more, the pore size inside the film and the surface irregularities are difficult to control.

Moreover, the viscosity of the film-forming composition (X) affects the pore shape of the film. When the film-forming composition (X) has a low viscosity, the shape of the pores is frequently determined by gaps between the polymer particles bonded to each other. When the viscosity is high, the shape is frequently determined by gaps between molecules of polymers that have precipitated to form a network structure. In other words, although the coatability and the evenness of the film thickness improve as the viscosity increases, the pore size and the surface irregularities become smaller and finer and thus the hydrophobicity tends to decrease. Accordingly, it is critical to adequately set the viscosity of the film-forming composition (X) by changing the relative contents of the polymerizable compound (A), the compound (B), and the polymer (C) and the relative content of the polymer (C) with respect to the compound (B) according to the desired performance of the superhydrophobic film such as transparency.

When film-forming composition (X) contains the polymer (C), the film-forming composition (X) may also contain a highly volatile liquid compound (D) as a constitutional component together with the compound (b) described above in the compound (B) since this is effective for decreasing the thickness of the superhydrophobic film to be prepared and increasing the transparency of the film.

The mixing ratio of the compound (b) to the compound (D) may be adequately set according to the desired performance of the superhydrophobic film, in particular, transparency.

### <Method for Producing a Patterned Film>

A patterned film having a superhydrophobic region and a hydrophilic region in the same surface of the film (in this description, this film is described as a patterned film having superhydrophobic and hydrophilic regions or a superhydrophobic/hydrophilic patterned film, for example) and a method for producing this film will now be described. Here, the “patterned film” means any film that has a superhydrophobic region and a hydrophilic region in the same surface of the film and the shape of the regions, i.e., the shape of the pattern, is not particularly limited. The shape may be irregular, circular, elliptical, egg-shaped, gourd-shaped, dumbbell-shaped, triangular, rectangular, polygonal, striped, wavy, repetition of a region having a particular shape, a geometric design, or any other shape. Furthermore, a superhydrophobic region and a hydrophilic region are not necessarily next to each other and may be separated from each other. However, in the present invention, a superhydrophobic region and a hydrophilic region are preferably adjacent to each other without any gap.

The superhydrophobic/hydrophilic patterned film of the present invention can be produced by performing two steps described below.

Step α: A step of preparing a film-forming composition (X) containing a polymerizable compound (A) that can be polymerized by energy ray irradiation and a compound (B) that is compatible with the polymerizable compound (A) but incompatible with a polymer (P_{A}) of the polymerizable compound (A) and that is inactive to the energy ray; forming a layer of the film-forming composition (X) on a substrate (S); irradiating the layer with an energy ray to polymerize the polymerizable compound (A) in the film-forming composition (X); and the removing the compound (B) to form a superhydrophobic film (SH) composed of a polymer and having surface irregularities.

Step β: A step of preparing a polymerizable composition (Y) containing a polymerizable compound (E) that has a hydrophilic chemical structural unit and that can be polymerized by energy ray irradiation; forming a layer of the polymerizable composition (Y) on a substrate (S); and polymerizing the polymerizable compound (E) in the polymerizable composition (Y) by energy ray irradiation to form a hydrophilic film (HP) composed of a polymer.

The order in which step α and step β are performed is not particularly limited. In the description above, the step to be performed second is performed on a film which has been formed by the first step instead of the substrate (S). In other words, when step α is performed second, the step is performed on the hydrophilic film (HP) composed of the polymer and when step β is performed second, the step is performed on the superhydrophobic film (SH) composed of the polymer having surface irregularities. However, step α is preferably conducted first and step β is conducted second in order to form a fine pattern of superhydrophobic regions and hydrophilic regions.

The step to be conducted second may be performed by any of the two methods described below: (1) A method in which a layer of the polymerizable composition is formed over the entirety of the film formed in the first step, the polymerizable compound in the polymerizable composition is polymerized by pattern-irradiation with the energy ray, and then the unpolymerized polymerizable composition in the non-irradiated portions is removed; and (2) a method in which a layer of the polymerizable composition is formed in parts of the film formed in the first step and then energy ray irradiation is conducted to polymerize the polymerizable compound in the polymerizable composition.

As described above, step α and step β may be conducted in any order. Accordingly, in this description, a first step of forming a layer of a composition on a substrate is denoted as step α1 and step β1, and a second step of forming another layer of a composition on the layer of the composition formed in the first step is denoted as step α2 and step β2. According to this notation, in the production method described in the “Solution to Problem” section, the step conducted first is denoted as step α1 and step β1 and the step conducted second is denoted as step α2 and step β2, respectively.

The respective steps will now be described.

### [Step α]

Step α is a step of forming a superhydrophobic film and there are two methods that can be used.

### (First Method)

According to a first method, a superhydrophobic film can be produced by forming, on a substrate (S), a thin layer of a film-forming composition (X) prepared by mixing a polymerizable compound (A) that can be polymerized by energy ray irradiation and a compound (B) that is compatible with the polymerizable compound (A) but incompatible with a polymer (P_{A}) of the polymerizable compound (A) and that is inactive to the energy ray, irradiating the thin layer with the energy ray to conduct polymerization, and removing the compound (B).

According to this method, the polymer (P_{A}) produced by polymerization of the polymerizable compound (A) is incompatible with the compound (B), a phase separation state is created between the polymer (P_{A}) and the compound (B), and the compound (B) is trapped in the polymer (P_{A}) or between the molecules of the polymer (P_{A}). Removing the compound (B) forms pores in regions previously occupied by the compound (B) to give irregularities on the film surface, and thus a superhydrophobic film can be formed.

### (Second Method)

According to a second method, a superhydrophobic film can be produced by forming, on a substrate (S), a thin layer of a film-forming composition (X) prepared by mixing a polymerizable compound (A) that can be polymerized by energy ray irradiation, a compound (B) that is compatible with the polymerizable compound (A) but incompatible with a polymer (P_{A}) of the polymerizable compound (A) and that is inactive to the energy ray, and a polymer (C) that is compatible with the polymerizable compound (A) and the compound (B) and inactive to the energy ray, irradiating the thin layer with the energy ray to conduct polymerization, and removing the compound (B).

According to this method, the polymer (P_{A}) produced by polymerization of the polymerizable compound (A) is incompatible with the compound (B), a phase separation state is created between the polymer (P_{A}) and the compound (B), and the compound (B) is trapped in the polymer (P_{A}) or between the molecules of the polymer (P_{A}). Removing the compound (B) forms pores in regions previously occupied by the compound (B) to give irregularities on the film surface, and thus a superhydrophobic film can be formed. All of the polymer (C) may be removed from the cured film of the film-forming composition (X) as long as the effects of the present invention are not impaired; however, at least part of the polymer (C) preferably remains in the cured film in order to ensure the strength of the cured film. Thus, the polymer (C) is preferably distributed in the polymer (P_{A}) phase to a particular degree among the polymer (P_{A}) and the compound (B) in a phase separation state. The higher the distribution ratio, the higher the strength of the cured film.

A highly transparent superhydrophobic film can be easily obtained by any of the production methods of the present invention. For example, a transparent superhydrophobic film having a transmittance of 80% or more for visible light having a wavelength of 600 nm has a thickness in the range of 0.02 to 1.00 μm and an average surface roughness (Ra) in the range of 10 to 100 nm.

Although the method for producing the superhydrophobic film on the substrate (S) by step α has been described in relation with the first method and the second method, the same applies to the case where step α is conducted after step β.

The method for energy ray pattern irradiation in the case where step α is conducted second may be any. For example, a photolithographic technique of irradiating the film while masking portions not to be irradiated with the energy ray or scanning a beam of an active energy ray such as a laser beam may be employed. The unpolymerized portions of the film-forming composition (X) not irradiated with the energy ray may be removed by washing with a solvent after the energy ray pattern irradiation. The solvent may be any solvent that is compatible with the film-forming composition (X). However, in order to simplify the drying operation, it is preferable to use a highly volatile general-purpose solvent such as methanol, ethanol, acetone, hexane, ethyl acetate, diethyl ether, and chloroform. When step α is to be conducted second, a device capable of accurately discharging particular amounts of liquid, such as an ink jet device or an XY robot, is preferably used to form a pattern by applying the film-forming composition (X). [Step β]

Step β is a step of applying the polymerizable composition (Y) containing the polymerizable compound (E) on the substrate (S) and forming a hydrophilic film (HP) by energy ray irradiation. For the polymerizable compound (E), a polymerizable compound (E) that can be polymerized by energy ray irradiation can be used alone or two or more types of such a compound may be used in combination. The polymerizable compound (E) may be any material that can be polymerized by irradiation with an energy ray and give a polymer, and may be a radically polymerizable compound, an anionically polymerizable compound, a cationically polymerizable compound, or the like. However, among polymerizable compounds (E) contained in the polymerizable compound (E), at least one preferably has a hydrophilic chemical structural unit. Preferable examples of the hydrophilic chemical structural unit include nonionic chemical structural units such as polyethylene glycol units, polyoxyethylene units, a hydroxyl group, a sugar-containing group, an amide bond, and a pyrrolidone unit; anionic chemical structural units such as a carboxy group, a sulfonic acid group, and a phosphoric acid group; cationic chemical structural units such as an amino group and an ammonium group; and a zwitter-ionic chemical structural units such as a chemical structural unit having an amino acid skeleton and a phosphoric acid group/ammonium group. A polymerizable compound having a vinyl group is used as the polymerizable compound (E). In particular, a (meth)acrylic compound that exhibits high polymerization rate by irradiation with an energy ray is preferred.

Examples of the polymerizable compound (E) having a hydrophilic chemical structural unit include a monomer having a hydroxyl group such as 2-hydroxyethyl (meth)acrylate, 2-hydroxypropyl (meth)acrylate, and glycerol mono(meth)acrylate; a monomer having a polyethylene glycol unit or a polyoxyethylene unit such as diethylene glycol mono(meth)acrylate, triethylene glycol mono(meth)acrylate, tetraethylene glycol mono(meth)acrylate, nonaethylene glycol mono(meth)acrylate, tetradecaethylene glycol mono(meth)acrylate, trieicosaethylene glycol mono(meth)acrylate, polyethylene glycol mono(meth)acrylate, methoxydiethylene glycol (meth)acrylate, methoxytriethylene glycol (meth)acrylate, methoxytetraethylene glycol (meth)acrylate, methoxynonaethylene glycol (meth)acrylate, methoxytetradecaethylene glycol (meth)acrylate, methoxytrieicosaethylene glycol (meth)acrylate, methoxypolyethylene glycol (meth)acrylate, phenoxydiethylene glycol (meth)acrylate, phenoxytetraethylene glycol (meth)acrylate, phenoxyhexaethylene glycol (meth)acrylate, phenoxynonaethylene glycol (meth)acrylate, phenoxy polyethylene glycol (meth)acrylate, nonylphenoxy polyethylene glycol (meth)acrylate, and nonylphenoxy polypropylene glycol (meth)acrylate;

a monomer having an amide bond such as N-ethyl (meth)acrylamide, N-n-propyl (meth)acrylamide, N-isopropyl (meth)acrylamide, N-cyclopropyl (meth)acrylamide, N-methyl-N-ethyl (meth)acrylamide, N,N-dimethyl (meth)acrylamide, N,N-diethyl (meth)acrylamide, N-methyl-N-isopropyl (meth)acrylamide, N-methyl-N-n-propyl (meth)acrylamide, N-(meth)acryloyl morpholine, N-(meth)acryloyl pyrrolidine, N-(meth)acryloyl piperidine, N-vinyl-2-pyrrolidine, N-methylenebisacrylamide, N-methoxypropyl (meth) acrylamide, N-isopropoxypropyl (meth) acrylamide, N-ethoxypropyl (meth)acrylamide, N-1-methoxymethylpropyl (meth)acrylamide, N-methoxyethoxypropyl (meth) acrylamide, N-1-methyl-2-methoxyethyl (meth) acrylamide, N-methyl-N-n-propyl (meth)acrylamide, and N-(1,3-dioxolan-2-yl)(meth)acrylamide; a monomer having an amino group such as N,N-dimethylaminoethyl (meth)acrylate, N,N-dimethylaminopropyl (meth)acrylamide, N,N-(bismethoxymethyl)carbamyloxyethyl methacrylate, and N-methoxymethylcarbamyloxyethyl methacrylate; a monomer having a carboxy group such as 2-(meth)acryloyloxyethyl phthalic acid, 2-(meth)acryloyloxypropyl phthalic acid, and 2-(meth)acryloyloxyethyl succinic acid; and a monomer having a phosphoric acid group such as mono(2-(meth)acryloyloxyethyl) acid phosphate;
a monomer having an ammonium group such as (meth)acryloyloxyethyl trimethyl ammonium chloride and (meth)acryloyloxypropyl trimethyl ammonium chloride; a monomer having a sulfonic acid group such as 2-acrylamide-2-methylpropane sulfonic acid, 2-acrylamido-2-phenyl propanesulfonic acid, sodium (meth) acryloyloxyethyl sulfonate, ammonium (meth) acryloyloxyethyl sulfonate, bis(polyoxyethylene polycyclic phenyl ether) methacrylate sulfonic acid ester salt, allyl sulfonic acid, methallyl sulfonic acid, vinylsulfonic acid, styrenesulfonic acid, and sulfonic acid sodium salt ethoxy methacrylate; and a polymerizable oligomer having any of these hydrophilic group and a molecular weight of 500 to 50000.

Among these, nonylphenoxypolyethylene glycol (meth)acrylate, N-ethyl (meth) acrylamide, N-isopropyl (meth)acrylamide, N,N-dimethyl (meth)acrylamide, mono(2-(meth)acryloyloxyethyl)acid phosphate, (meth)acryloyloxypropyltrimethyl ammonium chloride, sodium (meth)acryloyloxyethyl sulfonate, and bis(polyoxyethylene polycyclic phenyl ether) methacrylate sulfuric acid ester salt are preferred since a patterned film having a highly hydrophilic portion, in particular, a superhydrophilic portion exhibiting a water contact angle of 10° or less, can be provided.

A monofunctional monomer may be mixed with the polymerizable compound (E) to adjust the viscosity and impart functions such as adhesiveness and tackiness. The same compounds as the polymerizable compounds (a) that can be used in step 1 described above can be used as the monofunctional monomer.

If needed, a photopolymerization initiator, a polymerization delaying agent, a polymerization inhibitor, and the like may be mixed with the polymerizable composition (X). The photopolymerization initiator, the polymerization delaying agent, and the polymerization inhibitor for the film-forming composition (X) described above are suitable for use as the photopolymerization initiator, the polymerization delaying agent, and the polymerization inhibitor that can be added to the polymerization composition (Y), for example.

The viscosity of the polymerizable composition (Y) changes with the pore size and the extent of the surface irregularities of the superhydrophobic film. In order to have the polymerizable composition (Y) rapidly penetrate into the pores of the superhydrophobic film when this step is conducted after step α and completely remove the unreacted polymerizable composition (Y) from the pores after energy ray irradiation, the viscosity of the polymerizable composition (Y) at 25° C. is preferably in the range of 30 to 3,000 mPa·s and more preferably in the range of 100 to 1,000 mPa·s. When the viscosity is greater than 3,000 mPa·s, the polymerizable composition (Y) does not easily penetrate into inside the superhydrophobic film and it becomes difficult to remove the unreacted polymerizable composition (Y).

If needed, a solvent may be added to the polymerizable composition (Y). The type and amount of the solvent must be adequately controlled according to the additives added to the polymerizable compound (E) and the polymerizable composition (Y) used and the required viscosity, but a highly volatile solvent is preferably used. In such a case, the solvent evaporates after application of the polymerizable composition (Y) and before the polymerization process by energy ray irradiation. Thus, when this step is conducted after step α, a hydrophilic polymer formed of the polymerizable composition (Y) adsorbs to a surface of the polymer constituting the superhydrophobic film in the pores and on the surface of the superhydrophobic film after the polymerization by energy ray irradiation. Examples of the solvent used include alcohols such as methanol, ethanol, and 2-propanol, ketones such as acetone and 2-butanone, ethers such as tetrahydrofuran and 1,2-dimethoxyethane, water, and a mixed solvent thereof.

The method for applying the polymerizable composition (Y) to the superhydrophobic film may be any common known method. Preferable examples thereof include a dipping method, a roll coating method, a doctor blade method, a spin coating method, and a spraying method. When this step is to be conducted after step α, a device capable of accurately discharging particular amounts of liquid, such as an ink jet device or an XY robot, is preferably used to form a pattern by applying the polymerizable composition (Y).

The amount of the polymerizable composition (Y) applied is not particularly limited. When this step is conducted after step α and when the polymerizable composition (Y) not containing a solvent is applied, the amount of the composition applied is adjusted so that the upper end of a cured product of the polymerizable composition (Y) after energy ray irradiation is at the same level as the upper end of the superhydrophobic film. This is preferable in preparing a superhydrophobic/hydrophilic patterned film that has no difference in level.

The method for energy ray pattern irradiation in the case where step β is conducted second may be any. For example, a photolithographic technique of irradiating the film while masking portions not to be irradiated with the energy ray or scanning a beam of an active energy ray such as a laser beam may be employed. The unpolymerized portions of the polymerizable composition (Y) not irradiated with the energy ray may be removed after the energy ray pattern irradiation by washing with a solvent. The solvent may be any solvent that is compatible with the polymerizable composition (Y). However, in order to simplify the drying operation, it is preferable to use a highly volatile general-purpose solvent such as methanol, ethanol, acetone, hexane, ethyl acetate, diethyl ether, and chloroform.

The superhydrophobic/hydrophilic patterned film produced by the method described above has a structure including a hydrophilic region described below and a superhydrophobic region, which is a porous film having an aggregated particle structure in which polymer particles about 0.05 μm to 10 μm in diameter are aggregated and gaps between the particles form pores or a porous film having a three-dimensional network structure in which the polymer molecules are aggregated into a network structure, coexist in the same surface.

Case where production is conducted in the order of step α-step β (in the Solution to Problem section, the order is step α1-step β2): In step β, a hydrophilic region formed by using a solvent-free polymerizable composition (Y) takes a structure in which a cured product of the polymerizable composition (Y) mainly fills the pores of the superhydrophobic film. In many cases, the surface is flat and smooth. In contrast, a hydrophilic region formed by using a polymerizable composition (Y) containing a solvent takes a structure in which a cured product of the polymerizable composition (Y) mainly adheres on the surface of the polymer constituting the superhydrophobic film, and the porous structure is retained.

Case where production is conducted in the order of step β-step α (in the Solution to Problem section, the order is step β1-step α2): The hydrophilic region has a flat and smooth surface.

According to the production method of the present invention, a superhydrophobic/hydrophilic patterned film having a highly transparent superhydrophobic portion can be obtained. In such a case, the visible light transmittance of the superhydrophobic portion is 80% or more for a wavelength of 600 nm.

The water contact angle of the surface of the superhydrophobic/hydrophilic patterned film is 150° or more in the superhydrophobic portion. In contrast, the hydrophilic portion exhibits a water contact angle of 60° or less. In particular, the water contact angle of a superhydrophilic portion is 10° or less.

### EXAMPLES

The present invention will now be described in further detail by using Examples below. However, the scope of the present invention is not limited to the ranges of Examples below.

### Example 1

### [Preparation of Substrate]

Glass plate S-1111 produced by Matsunami Glass Ind., Ltd. (26 mm×76 mm, thickness: 1 mm) was immersed in a 5 mmol/L methanol solution of methacrylic acid 3-(trimethoxysilyl)propyl ester “M0725” produced by Tokyo Chemical Industry Co., Ltd., for 3 hours at 50° C., ultrasonically washed in methanol, and heated for 1 hour at a reduced pressure (0.01 Pa or less) in a thermostat at 100° C. to prepare a substrate [S-1].

### [Preparation of Superhydrophobic Film]

A polymerizable composition [A-1] was prepared by homogeneously mixing 6.94 g of ethylene glycol dimethacrylate “Light Ester EG” produced by KYOEISHA CHEMICAL Co., Ltd., 1.14 g of tert-butyl methacrylate “Light Ester TB” produced by KYOEISHA CHEMICAL Co., Ltd., 0.16 g of perfluorooctylethyl methacrylate “Light Ester FM-108” produced by KYOEISHA CHEMICAL Co., Ltd., and 0.18 g of 1-hydroxycyclohexyl phenyl ketone “IRGACURE 184” produced by Ciba-Geigy K.K., as the photopolymerization initiator Thereto, 5.23 g of methyl tetradecanoate was added and the resulting mixture was homogeneously mixed to prepare a film-forming composition [X-1].

The film-forming composition [X-1] was applied to the surface-treated substrate [S-1] using a spin coater under conditions of 1000 rpm and 10 seconds. The coating film was irradiated with ultraviolet light having an UV intensity of 40 mW/cm² at 365 nm using UE031-353CHC UV irradiator produced by EYE GRAPHICS Co., Ltd., using a 3000 W metal halide lamp as a light source for 3 minutes at room temperature in a nitrogen stream to polymerize the film-forming composition [X-1]. Then washing was conducted with ethanol and hexane. As a result, a superhydrophobic film [SH-1] having a thickness of 20 μm was obtained on the substrate.

### [Analysis of Superhydrophobic Film]

(1) Water contact angle: 152° (sliding angle: 1°)

Measuring instrument: Automated contact angle meter DM500 produced by Kyowa Interface Science Co., Ltd.

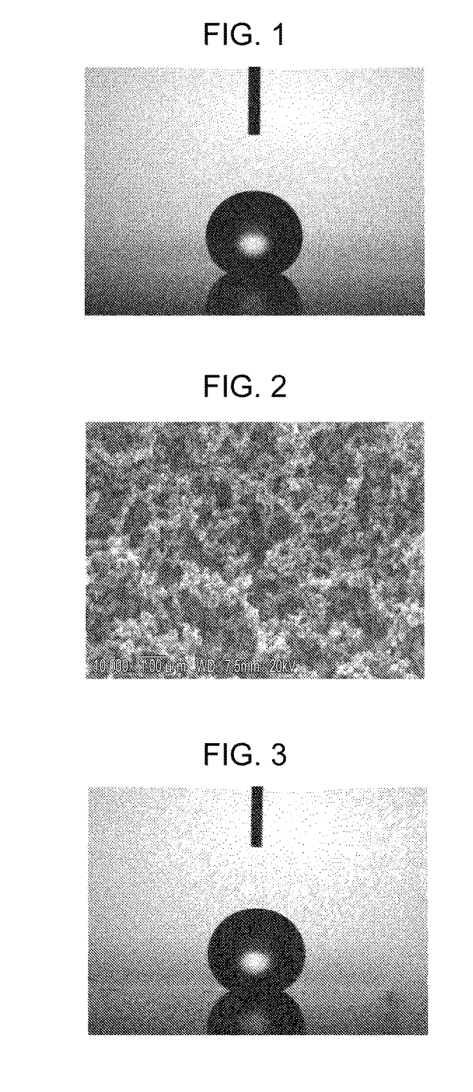

Volume of water drop: 4.0 μl (photograph of the water drop is shown in FIG. 1)

(2) Surface structure: A scanning electron microscope image of a film surface is shown in FIG. 2.

Measuring instrument: KEYENCE Real Surface View microscope VE-9800

(3) Average surface roughness (Ra) 280 nm

Measuring instrument (instrument (I)): Scanning type probe microscope (SPI3800N/SPA400) produced by SII NanoTechnology Inc.

Measurement mode: AFM

Scanning area: 10 μm×10 μm

(4) Reference value Average surface roughness (Ra): 260 nm

Measuring instrument (instrument (II)): KEYENCE Nanoscale Hybrid Microscope VN-8000

It was confirmed from the above described results that a superhydrophobic polymer film having irregularities on the surface was formed on a glass substrate.

### Example 2

### [Preparation of Substrate]

A methacrylic resin plate CLAREX S0 produced by Nitto Jushi Kogyo Co., Ltd. (thickness: 1 mm) was cut to form a substrate [S-2] (53 mm×80 mm).

### [Preparation of Superhydrophobic Film]

A superhydrophobic film [SH-2] having a thickness of 18 μm was obtained on a substrate as in Example 1 except that [S-2] was used as the substrate instead of [S-1].

### [Analysis of Superhydrophobic Film]

Water contact angle: 151° (sliding angle: 1°) (photograph of the water drop is shown in FIG. 3)

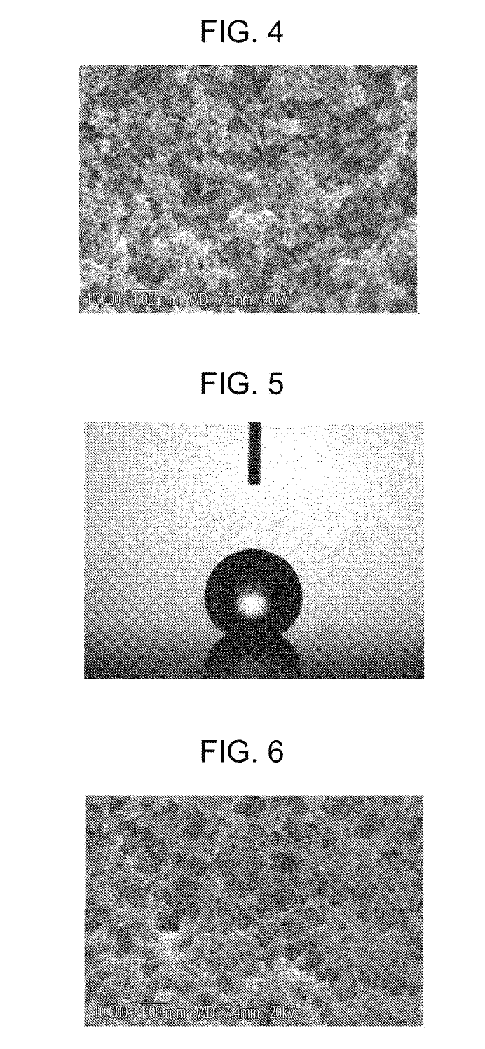

Surface structure: A scanning electron microscope image of a film surface is shown in FIG. 4.

(Instrument (I)) Average surface roughness (Ra): 290 nm

(Instrument (II)) Average surface roughness (Ra): 280 nm

Measuring instruments and measurement conditions are as described in Example 1.

It was confirmed from the above described results that a superhydrophobic polymer film having fine irregularities on the surface was formed on a methacrylic substrate.

### Example 3

### [Preparation of Substrate]

A biaxially stretched polyester film COSMOSHINE A4300 (thickness: 125 μm) produced by TOYOBO Co., LTD., was cut to prepare a substrate [S-3] (40 mm×50 mm).

### [Preparation of Superhydrophobic Film]

A superhydrophobic film [SH-3] having a thickness of 18 μm was obtained on a substrate as in Example 1 except that [S-3] was used as the substrate instead of [S-1].

### [Analysis of Superhydrophobic Film]

Water contact angle: 154° (sliding angle: 1°) (photograph of the water drop is shown in FIG. 5)

Surface structure: A scanning electron microscope image of a film surface is shown in FIG. 6.

(Instrument (I)) Average surface roughness (Ra): 260 nm

(Instrument (II)) Average surface roughness (Ra): 240 nm

Measuring instruments and measurement conditions are as described in Example 1.

It was confirmed from the above described results that a superhydrophobic polymer film having fine irregularities on the surface was formed on a polyester substrate.

### Example 4

### [Preparation of Superhydrophobic Film]

A polymerizable composition [A-4] was prepared by homogeneously mixing 6.87 g of 1,6-hexanediol dimethacrylate “Light Ester 1,6HX” produced by KYOEISHA CHEMICAL Co., Ltd., 1.27 g of n-laurylmethacrylate “Light Ester L” produced by KYOEISHA CHEMICAL Co., Ltd., 0.16 g of above-described “Light Ester FM-108”, and 0.18 g of “IRGACURE 184” as the photopolymerization initiator. Thereto, 9.14 g of tetradecane was added and the resulting mixture was homogeneously mixed to prepare a film-forming composition [X-4].

A superhydrophobic film [SH-4] having a thickness of 15 μm was obtained on a substrate as in Example 1 except that [X-4] was used instead of the film-forming composition [X-1].

### [Analysis of Superhydrophobic Film]

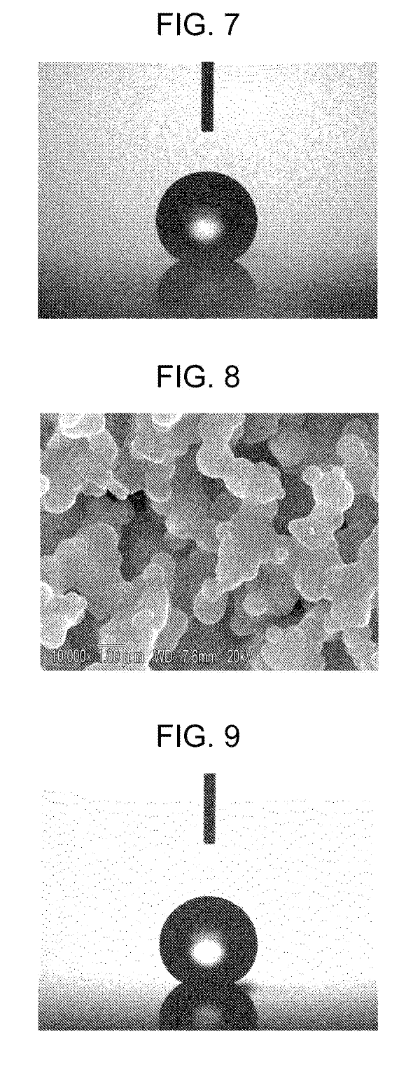

Water contact angle: 152° (sliding angle: 1°) (photograph of the water drop is shown in FIG. 7)

Surface structure: A scanning electron microscope image of a film surface is shown in FIG. 8.

(Instrument (I)) Average surface roughness (Ra): 320 nm

(Instrument (II)) Average surface roughness (Ra): 300 nm

Measuring instruments and measurement conditions are as described in Example 1.

It was confirmed from the above described results that a superhydrophobic polymer film having fine irregularities on the surface was formed on a glass substrate.

### Example 5

### [Preparation of Superhydrophobic Film]

A polymerizable composition [A-5] was prepared by homogeneously mixing 7.00 g of dimethylol tricyclodecane diacrylate “Light Acrylate DCP-A” produced by KYOEISHA CHEMICAL Co., Ltd., 1.02 g of isobutyl acrylate “AIB” produced by OSAKA ORGANIC CHEMICAL INDUSTRY LTD., 0.15 g of perfluorooctylethyl acrylate “Light Acrylate FA-108” produced by KYOEISHA CHEMICAL Co., Ltd., and 0.18 g of “IRGACURE 184” as the photopolymerization initiator. Thereto, 5.22 g of methyl hexadecanoate was added and the resulting mixture was homogeneously mixed to prepare a film-forming composition [X-5].

A superhydrophobic film [SH-5] having a thickness of 20 μm was obtained on a substrate as in Example 1 except that [X-5] was used instead of the film-forming composition [X-1].

### [Analysis of Superhydrophobic Film]

Water contact angle: 150° (sliding angle: 1°) (photograph of the water drop is shown in FIG. 9)

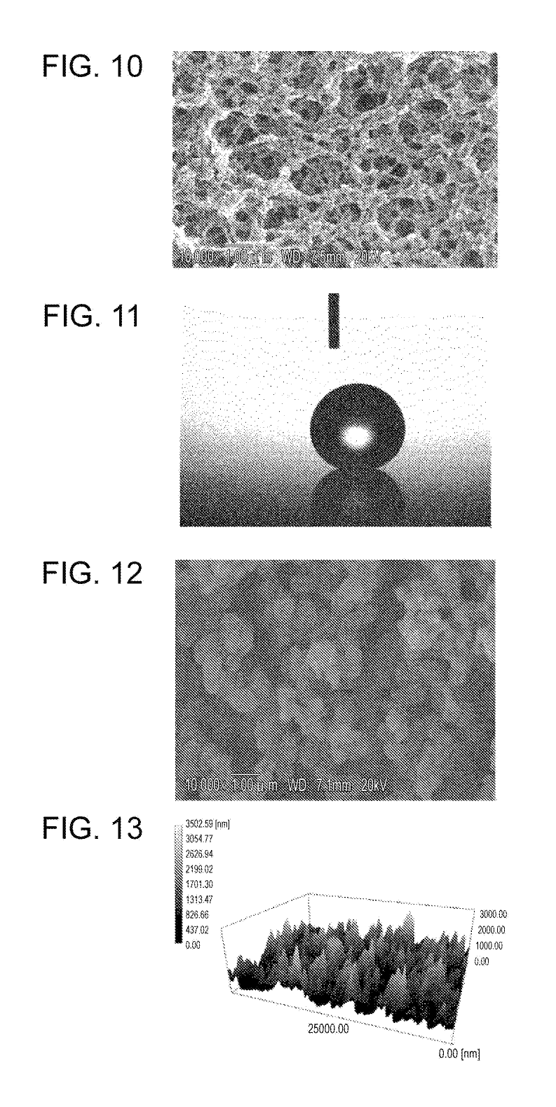

Surface structure: A scanning electron microscope image of a film surface is shown in FIG. 10.

(Instrument (I)) Average surface roughness (Ra): 220 nm

(Instrument (II)) Average surface roughness (Ra): 210 nm

Measuring instruments and measurement conditions are as described in Example 1.

It was confirmed from the above described results that a superhydrophobic polymer film having fine irregularities on the surface was formed on a glass substrate.

### Comparative Example 1

### [Preparation of Energy Ray-Cured Film]

A polymerizable compound [A-1] was prepared as in Example 1. Thereto, 4.65 g of methyl hexanoate was added and the resulting mixture was homogeneously mixed to prepare a film-forming composition [XR-1].

Then an energy ray-cured film [R-1] having a thickness of 14 μm was obtained on a substrate as in Example 1 except that [XR-1] was used instead of the film-forming composition [X-1].

### [Analysis of Energy Ray-Cured Film]

Water contact angle: 65°

Surface structure: evaluated by using a scanning electron microscope.

(Instrument (I)) Average surface roughness (Ra): 3.2 nm

Measuring instruments and measurement conditions are as described in Example 1.

As described above, the energy ray-cured film prepared by using a film-forming composition that contains methyl hexanoate having a saturation vapor pressure of 670 Pa at 25° C. used as the compound (B) did not exhibit superhydrophobicity.

### Comparative Example 2

### [Preparation of Energy Ray-Cured Film]

A polymerizable compound [A-4] was prepared as in Example 4. Thereto, 4.65 g of methyl hexanoate was added and the resulting mixture was homogeneously mixed to prepare a film-forming composition [XR-2].

Then an energy ray-cured film [R-2] having a thickness of 16 μm was obtained on a substrate as in Example 1 except that [XR-2] was used instead of the film-forming composition [X-1].

### [Analysis of Energy Ray-Cured Film]

Water contact angle: 68°

Surface structure: evaluated by using a scanning electron microscope.

(Instrument (I)) Average surface roughness (Ra): 2.5 nm

Measuring instruments and measurement conditions are as described in Example 1.

As described above, the energy ray-cured film prepared by using a film-forming composition that contains methyl hexanoate having a saturation vapor pressure of 670 Pa at 25° C. used as the compound (B) did not exhibit superhydrophobicity.

### Comparative Example 3

### [Preparation of Energy Ray-Cured Film]

A polymerizable compound [A-5] was prepared as in Example 5. Thereto, 4.65 g of methyl hexanoate was added and the resulting mixture was homogeneously mixed to prepare a film-forming composition [XR-3].

Then an energy ray-cured film [R-3] having a thickness of 14 μm was obtained on a substrate as in Example 1 except that [XR-3] was used instead of the film-forming composition [X-1].

### [Analysis of Energy Ray-Cured Film]

Water contact angle: 65°

(Instrument (I)) Average surface roughness (Ra): 1.9 nm

Surface structure: evaluated by using a scanning electron microscope.

Measuring instruments and measurement conditions are as described in Example 1.

As described above, the energy ray-cured film prepared by using a film-forming composition that contains methyl hexanoate having a saturation vapor pressure of 670 Pa at 25° C. used as the compound (B) did not exhibit superhydrophobicity.

### Example 6

### [Preparation of Substrate]

A substrate [S-1] was prepared as in Example 1.

### [Preparation of Superhydrophobic Film]

A polymerizable compound [A-1] was prepared as in Example 1. Thereto, 4.64 g of methyl decanoate and 0.52 g of polyisobutyl methacrylate (weight-average molecular weight: 300,000) produced by Aldrich were added and the resulting mixture was homogeneously mixed to prepare a film-forming composition [X-6].

The film-forming composition [X-6] was applied to the surface-treated substrate [S-1] using a spin coater under conditions of 1000 rpm and 10 seconds. The coating film was irradiated with ultraviolet light having an UV intensity of 40 mW/cm² at 365 nm using a UE031-353CHC UV irradiator produced by EYE GRAPHICS Co., Ltd., using a 3000 W metal halide lamp as a light source for 3 minutes at room temperature in a nitrogen stream to polymerize the film-forming composition [X-6]. Then washing was conducted with ethanol and hexane. As a result, a superhydrophobic film [SH-6] having a thickness of 18 μm was obtained on the substrate.

### [Analysis of Superhydrophobic Film]

Water contact angle: 160° (sliding angle: 1°)

Measuring instrument: Automated contact angle meter DM500 produced by Kyowa Interface Science Co., Ltd.

Volume of water drop: 4.0 μl (photograph of the water drop is shown in FIG. 11)

Surface structure: A scanning electron microscope image of a film surface is shown in FIG. 12.

Measuring instrument: KEYENCE Real Surface View microscope VE-9800

Acceleration voltage: 20 kV

(Instrument (I)) Average surface roughness (Ra): 390 nm (an atomic force microscope image of the film surface is shown in FIG. 13.)

(Instrument (II)) Average surface roughness (Ra): 360 nm

Measuring instruments and measurement conditions are as described in Example 1.

It was confirmed from the above described results that a superhydrophobic polymer film having fine irregularities on the surface was formed on a glass substrate.

### Example 7

### [Preparation of Substrate]

A substrate [S-2] was prepared as in Example 2.

### [Preparation of Superhydrophobic Film]

A superhydrophobic film [SH-7] having a thickness of 19 μm was obtained on a substrate as in Example 6 except that [S-2] was used as the substrate instead of [S-1].

### [Analysis of Superhydrophobic Film]

Water contact angle: 161° (sliding angle: 1°)

Surface structure: evaluated by using a scanning electron microscope.

(Instrument (I)) Average surface roughness (Ra): 350 nm

(Instrument (II)) Average surface roughness (Ra): 330 nm

Measuring instruments and measurement conditions are as described in Example 1.

It was confirmed from the above described results that a superhydrophobic polymer film having fine irregularities on the surface was formed on a methacrylic substrate.

### Example 8

### [Preparation of Substrate]

A substrate [S-3] was prepared as in Example 3.

### [Preparation of Superhydrophobic Film]

A superhydrophobic film [SH-8] having a thickness of 18 μm was obtained on a substrate as in Example 6 except that [S-3] was used as the substrate instead of [S-1].

### [Analysis of Superhydrophobic Film]

Water contact angle: 162° (sliding angle: 1°)

Surface structure: evaluated by using a scanning electron microscope.

(Instrument (I)) Average surface roughness (Ra): 360 nm

(Instrument (II)) Average surface roughness (Ra): 340 nm

Measuring instruments and measurement conditions are as described in Example 1.

It was confirmed from the above described results that a superhydrophobic polymer film having fine irregularities on the surface was formed on a polyester substrate.

### Example 9

### [Preparation of Superhydrophobic Film]

A polymerizable compound [A-1] was prepared as in Example 6. Thereto, 4.59 g of ethyl phenylacetate and 0.52 g of polyisobutyl methacrylate (weight-average molecular weight: 300,000) produced by Aldrich were added and the resulting mixture was homogeneously mixed to prepare a film-forming composition [X-9].

A superhydrophobic film [SH-9] having a thickness of 22 μm was obtained on a substrate as in Example 6 except that [X-9] was used instead of the film-forming composition [X-6].

### [Analysis of Superhydrophobic Film]

Water contact angle: 157° (sliding angle: 1°)

Surface structure: evaluated by using a scanning electron microscope.

(Instrument (I)) Average surface roughness (Ra): 330 nm

(Instrument (II)) Average surface roughness (Ra): 320 nm

Measuring instruments and measurement conditions are as described in Example 1.

It was confirmed from the above described results that a superhydrophobic polymer film having fine irregularities on the surface was formed on a glass substrate.

### Example 10

### [Preparation of Superhydrophobic Film]

A polymerizable compound [A-1] was prepared as in Example 6. Thereto, 4.72 g of tetradecane and 0.52 g of polyisobutyl methacrylate (weight-average molecular weight: 300,000) produced by Aldrich were added and the resulting mixture was homogeneously mixed to prepare a film-forming composition [X-10].

A superhydrophobic film [SH-10] having a thickness of 21 μm was obtained on a substrate as in Example 6 except that [X-4] was used instead of the film-forming composition [X-6].

### [Analysis of Superhydrophobic Film]

Water contact angle: 153° (sliding angle: 1°)

Surface structure: evaluated by using a scanning electron microscope.

(Instrument (I)) Average surface roughness (Ra): 420 nm

(Instrument (II)) Average surface roughness (Ra): 390 nm

Measuring instruments and measurement conditions are as described in Example 1.

It was confirmed from the above described results that a superhydrophobic polymer film having fine irregularities on the surface was formed on a glass substrate.

### Example 11

### [Preparation of Superhydrophobic Film]

A polymerizable compound [A-1] was prepared as in Example 6. Thereto, 4.65 g of isobutyl benzene and 0.52 g of polyisobutyl methacrylate (weight-average molecular weight: 300,000) produced by Aldrich were added and the resulting mixture was homogeneously mixed to prepare a film-forming composition [X-11].

A superhydrophobic film [SH-11] having a thickness of 25 μm was obtained on a substrate as in Example 6 except that [X-11] was used instead of the film-forming composition [X-6].

### [Analysis of Superhydrophobic Film]

Water contact angle: 161° (sliding angle: 1°)

Surface structure: evaluated by using a scanning electron microscope.

(Instrument (I)) Average surface roughness (Ra): 370 nm

(Instrument (II)) Average surface roughness (Ra): 350 nm

Measuring instruments and measurement conditions are as described in Example 1.

It was confirmed from the above described results that a superhydrophobic polymer film having fine irregularities on the surface was formed on a glass substrate.

### Example 12

### [Preparation of Superhydrophobic Film]

A polymerizable compound [A-1] was prepared as in Example 6. Thereto, 4.64 g of diethylene glycol dibutyl ether and 0.52 g of polyisobutyl methacrylate (weight-average molecular weight: 300,000) produced by Aldrich were added and the resulting mixture was homogeneously mixed to prepare a film-forming composition [X-12].

A superhydrophobic film [SH-12] having a thickness of 20 μm was obtained on a substrate as in Example 6 except that [X-12] was used instead of the film-forming composition [X-6].

### [Analysis of Superhydrophobic Film]

Water contact angle: 159° (sliding angle: 1°)

Surface structure: evaluated by using a scanning electron microscope.

(Instrument (I)) Average surface roughness (Ra): 370 nm

(Instrument (II)) Average surface roughness (Ra): 340 nm

Measuring instruments and measurement conditions are as described in Example 1.

It was confirmed from the above described results that a superhydrophobic polymer film having fine irregularities on the surface was formed on a glass substrate.

### Example 13

### [Preparation of Superhydrophobic Film]

A polymerizable compound [A-1] was prepared as in Example 6. Thereto, 4.64 g of methyl decanoate and 0.52 g of polyethyl methacrylate (weight-average molecular weight: 340,000) produced by Aldrich were added and the resulting mixture was homogeneously mixed to prepare a film-forming composition [X-13].

A superhydrophobic film [SH-13] having a thickness of 17 μm was obtained on a substrate as in Example 6 except that [X-13] was used instead of the film-forming composition [X-6].

### [Analysis of Superhydrophobic Film]

Water contact angle: 155° (sliding angle: 1°)

Surface structure: evaluated by using a scanning electron microscope.

(Instrument (I)) Average surface roughness (Ra): 310 nm

(Instrument (II)) Average surface roughness (Ra): 300 nm

Measuring instruments and measurement conditions are as described in Example 1.

It was confirmed from the above described results that a superhydrophobic polymer film having fine irregularities on the surface was formed on a glass substrate.

### Example 14

### [Preparation of Superhydrophobic Film]

A polymerizable compound [A-1] was prepared as in Example 6. Thereto, 4.64 g of methyl decanoate and 0.50 g of polyisobornyl methacrylate (weight-average molecular weight: 554,000) produced by Aldrich were added and the resulting mixture was homogeneously mixed to prepare a film-forming composition [X-14].

A superhydrophobic film [SH-14] having a thickness of 20 μm was obtained on a substrate as in Example 6 except that [X-14] was used instead of the film-forming composition [X-6].

### [Analysis of Superhydrophobic Film]

Water contact angle: 153° (sliding angle: 1°)

Surface structure: evaluated by using a scanning electron microscope.

(Instrument (I)) Average surface roughness (Ra): 320 nm

(Instrument (II)) Average surface roughness (Ra): 310 nm

Measuring instruments and measurement conditions are as described in Example 1.

It was confirmed from the above described results that a superhydrophobic polymer film having fine irregularities on the surface was formed on a glass substrate.

### Example 15

### [Preparation of Superhydrophobic Film]

A polymerizable compound [A-1] was prepared as in Example 6. Thereto, 4.64 g of methyl decanoate and 0.48 g of polystyrene (weight-average molecular weight: 280,000) produced by Aldrich were added and the resulting mixture was homogeneously mixed to prepare a film-forming composition [X-15].

A superhydrophobic film [SH-15] having a thickness of 19 μm was obtained on a substrate as in Example 6 except that [X-15] was used instead of the film-forming composition [X-6].

### [Analysis of Superhydrophobic Film]

Water contact angle: 150° (sliding angle: 2°)

Surface structure: evaluated by using a scanning electron microscope.

(Instrument (I)) Average surface roughness (Ra): 300 nm

(Instrument (II)) Average surface roughness (Ra): 290 nm

Measuring instruments and measurement conditions are as described in Example 1.

It was confirmed from the above described results that a superhydrophobic polymer film having fine irregularities on the surface was formed on a glass substrate.

### Example 16

### [Preparation of Superhydrophobic Film]

A polymerizable compound [A-4] was prepared as in Example 4. Thereto, 4.64 g of methyl decanoate and 0.52 g of polyisobutyl methacrylate (weight-average molecular weight: 300,000) were added and the resulting mixture was homogeneously mixed to prepare a film-forming composition [X-16].

A superhydrophobic film [SH-16] having a thickness of 19 μm was obtained on a substrate as in Example 6 except that [X-16] was used instead of the film-forming composition [X-6].

### [Analysis of Superhydrophobic Film]

Water contact angle: 158° (sliding angle: 1°)

Surface structure: evaluated by using a scanning electron microscope.

(Instrument (I)) Average surface roughness (Ra): 320 nm

(Instrument (II)) Average surface roughness (Ra): 310 nm

Measuring instruments and measurement conditions are as described in Example 1.

It was confirmed from the above described results that a superhydrophobic polymer film having fine irregularities on the surface was formed on a glass substrate.

### Example 17

### [Preparation of Superhydrophobic Film]

A polymerizable compound [A-5] was prepared as in Example 5. Thereto, 4.64 g of methyl decanoate and 0.52 g of polyisobutyl methacrylate (weight-average molecular weight: 300,000) were added and the resulting mixture was homogeneously mixed to prepare a film-forming composition [X-17].

A superhydrophobic film [SH-17] having a thickness of 24 μm was obtained on a substrate as in Example 6 except that [X-17] was used instead of the film-forming composition [X-6].

### [Analysis of Superhydrophobic Film]

Water contact angle: 156° (sliding angle: 1°)

Surface structure: evaluated by using a scanning electron microscope.

(Instrument (I)) Average surface roughness (Ra): 410 nm

(Instrument (II)) Average surface roughness (Ra): 390 nm

Measuring instruments and measurement conditions are as described in Example 1.

It was confirmed from the above described results that a superhydrophobic polymer film having fine irregularities on the surface was formed on a glass substrate.

### Example 18

### [Preparation of Superhydrophobic Film]

A polymerizable compound [A-1] was prepared as in Example 6. Thereto, 4.72 g of methyl tetradecanoate and 0.52 g of polyisobutyl methacrylate (weight-average molecular weight: 300,000) produced by Aldrich were added and the resulting mixture was homogeneously mixed to prepare a film-forming composition [X-18].

The film-forming composition [X-18] was applied to the surface-treated substrate [S-1] as in Example 6 by using a spin coater under conditions of 4000 rpm and 25 seconds. The coating film was polymerized as in Example 6 and washed to form a superhydrophobic film [SH-18] having a thickness of 1.0 μm on a substrate.

### [Analysis of Superhydrophobic Film]

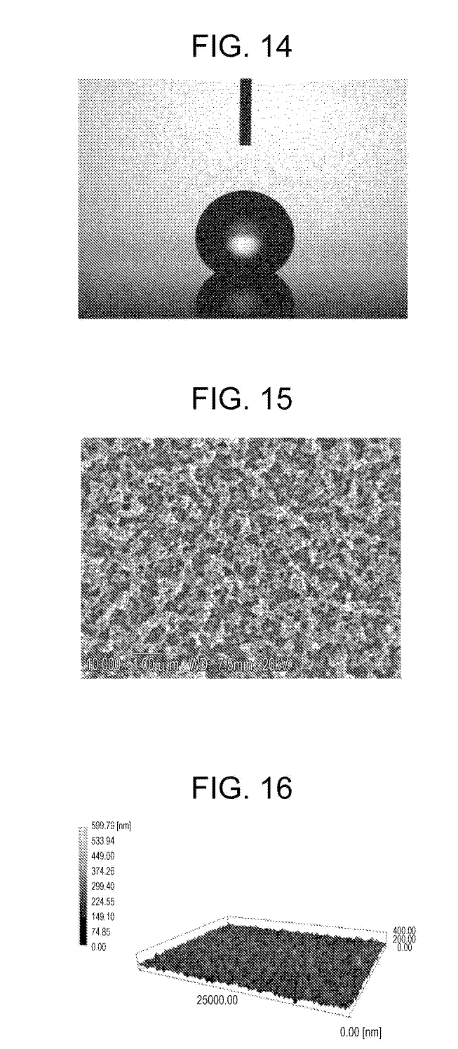

Water contact angle: 155° (sliding angle: 1°) (photograph of the water drop is shown in FIG. 14)

Surface structure: A scanning electron microscope image of a film surface is shown in FIG. 15.

(Instrument (I)) Average surface roughness (Ra): 52 nm (an atomic force microscope image of the film surface is shown in FIG. 16.)

(Instrument (II)) Average surface roughness (Ra): 43 nm

Measuring instruments and measurement conditions are as described in Example 1.

Visible light transmittance: 92.0% (wavelength: 540 nm), 95.3% (wavelength: 600 nm)

Measuring instrument: Hitachi UV-Visible Spectrophotometer U-4100

It was confirmed from the above described results that a superhydrophobic polymer film having high transparency and fine irregularities on the surface was formed on a glass substrate.

### Example 19

### [Preparation of Superhydrophobic Film]

A polymerizable compound [A-5] was prepared as in Example 17. Thereto, 4.75 g of methyl hexadecanoate and 0.52 g of polyisobutyl methacrylate (weight-average molecular weight: 300,000) produced by Aldrich were added and the resulting mixture was homogeneously mixed to prepare a film-forming composition [X-19].

The film-forming composition [X-19] was applied to the surface-treated substrate [S-1] as in Example 6 by using a spin coater under conditions of 7000 rpm and 25 seconds.

The coating film was polymerized as in Example 6 and washed to form a superhydrophobic film [SH-19] having a thickness of 0.7 μm on a substrate.

### [Analysis of Superhydrophobic Film]

Water contact angle: 154° (sliding angle: 1°)

Surface structure: evaluated by using a scanning electron microscope.

(Instrument (I)) Average surface roughness (Ra): 50 nm

(Instrument (II)) Average surface roughness (Ra): 35 nm

Visible light transmittance: 95.4% (wavelength: 540 nm), 98.0% (wavelength: 600 nm)

Measuring instruments and measurement conditions are as described in Example 1 and Example 18.

It was confirmed from the above described results that a superhydrophobic polymer film having high transparency and fine irregularities on the surface was formed on a glass substrate.

### Example 20

### [Preparation of Superhydrophobic Film]

A film-forming composition [X-6] was prepared as in Example 6. Thereto, 50.5 g of ethyl acetate was added and the resulting mixture was homogeneously mixed to prepare a film-forming composition [X-20].

The film-forming composition [X-20] was applied to the surface-treated substrate [S-1] as in Example 6 by using a spin coater under conditions of 2000 rpm and 180 seconds. The coating film was polymerized as in Example 6 and washed to form a superhydrophobic film [SH-20] having a thickness of 0.5 μm on a substrate.

### [Analysis of Superhydrophobic Film]

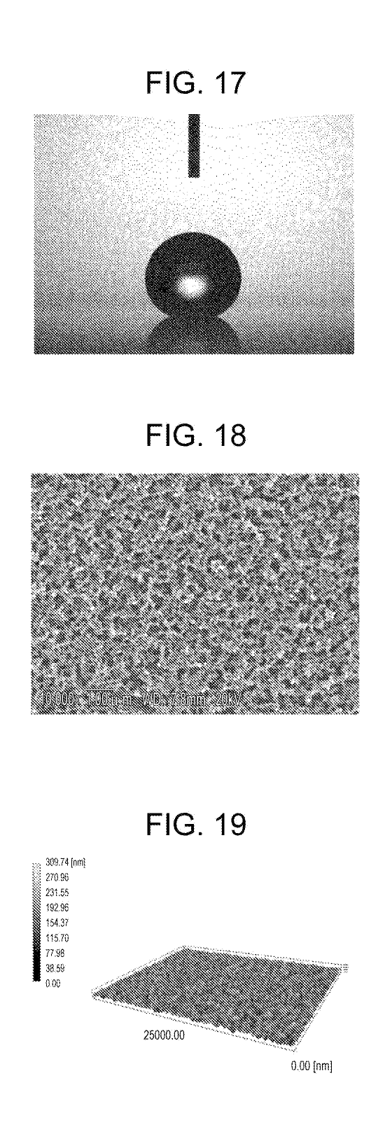

Water contact angle: 151° (sliding angle: 2°) (photograph of the water drop is shown in FIG. 17)

Surface structure: A scanning electron microscope image of a film surface is shown in FIG. 18.

(Instrument (I)) Average surface roughness (Ra): 46 nm (an atomic force microscope image of the film surface is shown in FIG. 19.)

(Instrument (II)) Average surface roughness (Ra): 30 nm

Visible light transmittance: 95.9% (wavelength: 540 nm), 98.0% (wavelength: 600 nm)

Measuring instruments and measurement conditions are as described in Example 1 and Example 18.

It was confirmed from the above described results that a superhydrophobic polymer film having high transparency and fine irregularities on the surface was formed on a glass substrate.

### Example 21

### [Preparation of Superhydrophobic Film]

A film-forming composition [X-6] was prepared as in Example 6. Thereto, 9.23 g of hexane was added and the resulting mixture was homogeneously mixed to prepare a film-forming composition [X-21].

The film-forming composition [X-21] was applied to the surface-treated substrate [S-1] as in Example 6 by using a spin coater under conditions of 2000 rpm and 180 seconds. The coating film was polymerized as in Example 6 and washed to form a superhydrophobic film [SH-21] having a thickness of 0.6 μm on a substrate.

### [Analysis of Superhydrophobic Film]

Water contact angle: 150° (sliding angle: 2°)

Surface structure: evaluated by using a scanning electron microscope.

(Instrument (I)) Average surface roughness (Ra): 53 nm

(Instrument (II)) Average surface roughness (Ra): 38 nm

Visible light transmittance: 95.9% (wavelength: 540 nm), 99.2% (wavelength: 600 nm)

Measuring instruments and measurement conditions are as described in Example 1 and Example 18.

It was confirmed from the above described results that a superhydrophobic polymer film having high transparency and fine irregularities on the surface was formed on a glass substrate.

### Example 22

### [Preparation of Superhydrophobic Film]

A film-forming composition [X-6] was prepared as in Example 6. Thereto, 9.25 g of toluene was added and the resulting mixture was homogeneously mixed to prepare a film-forming composition [X-22].

The film-forming composition [X-22] was applied to the surface-treated substrate [S-1] as in Example 6 by using a spin coater under conditions of 2000 rpm and 180 seconds. The coating film was polymerized as in Example 6 and washed to form a superhydrophobic film [SH-22] having a thickness of 0.5 μm on a substrate.

### [Analysis of Superhydrophobic Film]

Water contact angle: 152° (sliding angle: 2°)

Surface structure: evaluated by using a scanning electron microscope.

(Instrument (I)) Average surface roughness (Ra): 51 nm

(Instrument (II)) Average surface roughness (Ra): 33 nm

Visible light transmittance: 98.1% (wavelength: 540 nm), 99.0% (wavelength: 600 nm)

Measuring instruments and measurement conditions are as described in Example 1 and Example 18.

It was confirmed from the above described results that a superhydrophobic polymer film having high transparency and fine irregularities on the surface was formed on a glass substrate.

### Example 23

### [Preparation of Superhydrophobic Film]

A film-forming composition [X-6] was prepared as in Example 6. Thereto, 50.4 g of chloroform was added and the resulting mixture was homogeneously mixed to prepare a film-forming composition [X-23].

The film-forming composition [X-23] was applied to the surface-treated substrate [S-1] as in Example 6 by using a spin coater under conditions of 2000 rpm and 180 seconds. The coating film was polymerized as in Example 6 and washed to form a superhydrophobic film [SH-23] having a thickness of 0.6 μm on a substrate.

### [Analysis of Superhydrophobic Film]

Water contact angle: 151° (sliding angle: 2°)

Surface structure: evaluated by using a scanning electron microscope.

(Instrument (I)) Average surface roughness (Ra): 43 nm

(Instrument (II)) Average surface roughness (Ra): 28 nm

Visible light transmittance: 96.1% (wavelength: 540 nm), 98.7% (wavelength: 600 nm)

Measuring instruments and measurement conditions are as described in Example 1 and Example 18.

It was confirmed from the above described results that a superhydrophobic polymer film having high transparency and fine irregularities on the surface was formed on a glass substrate.

### Comparative Example 4

### [Preparation of Energy Ray-Cured Film]

A polymerizable compound [A-1] was prepared as in Example 6. Thereto, 0.52 g of polyisobutyl methacrylate (weight-average molecular weight: 300,000) produced by Aldrich was added and the resulting mixture was homogeneously mixed to prepare a film-forming composition [XR-4].

Then an energy ray-cured film [R-4] having a thickness of 19 μm was obtained on a substrate as in Example 6 except that [XR-4] was used instead of the film-forming composition [X-6].

### [Analysis of Energy Ray-Cured Film]

Water contact angle: 108°

Surface structure: evaluated by using a scanning electron microscope.

(Instrument (I)) Average surface roughness (Ra): 17 nm

Measuring instruments and measurement conditions are as described in Example 1.

As described above, the energy ray-cured film prepared from a film-forming composition not containing the compound (B) exhibited a water contact angle lower than that of the superhydrophobic film of Example 6 and did not exhibit superhydrophobicity.

### Comparative Example 5

### [Preparation of Energy Ray-Cured Film]

A polymerizable compound [A-1] was prepared as in Example 6. Thereto, 0.52 g of polyethyl methacrylate (weight-average molecular weight: 340,000) produced by Aldrich was added and the resulting mixture was homogeneously mixed to prepare a film-forming composition [XR-5].

Then an energy ray-cured film [R-5] having a thickness of 17 μm was obtained on a substrate as in Example 6 except that [XR-5] was used instead of the film-forming composition [X-6].

### [Analysis of Energy Ray-Cured Film]

Water contact angle: 98°

Surface structure: evaluated by using a scanning electron microscope.

(Instrument (I)) Average surface roughness (Ra): 20 nm

Measuring instruments and measurement conditions are as described in Example 1.

As described above, the energy ray-cured film prepared from a film-forming composition not containing the compound (B) exhibited a water contact angle lower than that of the superhydrophobic film of Example 6 and did not exhibit superhydrophobicity.

### Comparative Example 6

### [Preparation of Energy Ray-Cured Film]

A polymerizable compound [A-5] was prepared as in Example 17. Thereto, 0.48 g of polystyrene (weight-average molecular weight: 280,000) produced by Aldrich was added and the resulting mixture was homogeneously mixed to prepare a film-forming composition [XR-6].

Then an energy ray-cured film [R-6] having a thickness of 14 μm was obtained on a substrate as in Example 1 except that [XR-6] was used instead of the film-forming composition [X-6].

### [Analysis of Energy Ray-Cured Film]

Water contact angle: 78°

Surface structure: evaluated by using a scanning electron microscope.

(Instrument (I)) Average surface roughness (Ra): 15 nm

Measuring instruments and measurement conditions are as described in Example 1.

As described above, the energy ray-cured film prepared from a film-forming composition not containing the compound (B) did not exhibit superhydrophobicity.

### Example 24

### [Step α]

### [Preparation of Substrate]

A substrate [S-1] was prepared as in Example 1.

### [Preparation of Superhydrophobic Film]

A polymerizable compound [A-1] was prepared as in Example 1. Thereto, 4.64 g of methyl decanoate and 0.52 g of polyisobutyl methacrylate (weight-average molecular weight: 300,000) produced by Aldrich were added and the resulting mixture was homogeneously mixed to prepare a polymerizable composition [X-24].

The polymerizable composition [X-24] was applied to the surface-treated substrate [S-1] using a spin coater under conditions of 1000 rpm and 10 seconds. The coating film was irradiated with ultraviolet light having an UV intensity of 40 mW/cm² at 365 nm using a UE031-353CHC UV irradiator produced by EYE GRAPHICS Co., Ltd., using a 3000 W metal halide lamp as a light source (hereinafter referred to as “lamp 1”) for 3 minutes at room temperature in a nitrogen stream to polymerize the polymerizable composition [X-24]. Then washing was conducted with ethanol and hexane. As a result, a superhydrophobic film [SH-24] having a thickness of 18 μm was obtained on the substrate.

### [Analysis of Superhydrophobic Film]

Water contact angle: 159° (sliding angle: 1°)

Measuring instruments and measurement conditions are as described in Example 1.

Measuring instrument: Automated contact angle meter DM500 produced by Kyowa Interface Science Co., Ltd.

Volume of water drop: 4.0 μl

It was confirmed from the above described results that a superhydrophobic polymer film was formed on a glass substrate.

### [Step β]

### [Preparation of Superhydrophobic/Hydrophilic Patterned Film]

A polymerizable composition [Y-1] was prepared by homogeneously mixing 3.00 g of EO-modified isocyanurate diacrylate “ARONIX M-215” produced by TOAGOSEI CO., LTD., 2.00 g of EO-modified nonylphenol acrylate “NEW FRONTIER N-177E” produced by DAI-ICHI KOGYO SEIYAKU CO., LTD., and 0.01 g of 1-hydroxycyclohexyl phenyl ketone “IRGACURE 184” produced by Ciba-Geigy K.K. as the photopolymerization initiator.

The polymerizable composition [Y-1] was applied to the superhydrophobic film [SH-24] on the substrate [S-1] using a spin coater under conditions of 7000 rpm and 25 seconds. Then portions to remain superhydrophobic was photo-masked, and ultraviolet light having an UV intensity of 50 mW/cm² at 365 nm was applied for 185 seconds using Multilight 250 W series exposure light source unit (hereinafter referred to as a “lamp 2”) using a 250 W high-pressure mercury lamp as a light source. Then washing was conducted with ethanol to remove the unreacted composition [Y-1]. As a result, a superhydrophobic/hydrophilic patterned film [SHL-1] was prepared.

### [Analysis of Superhydrophobic/Hydrophilic Patterned Film]

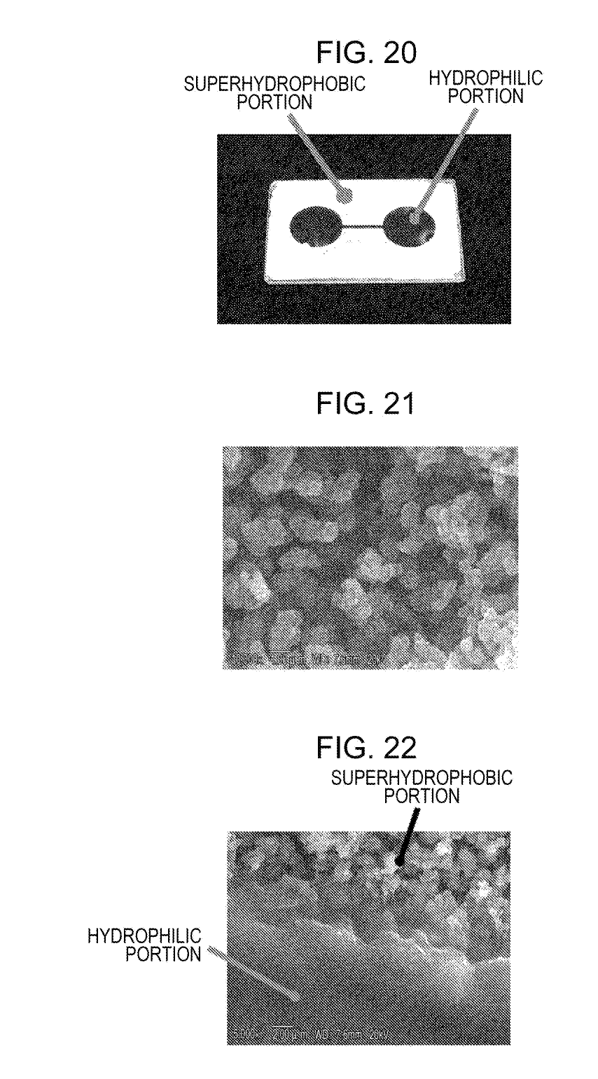

Appearance: An image of the appearance of the film is shown in FIG. 20.

### [Superhydrophobic Portion]

Water contact angle: 159° (sliding angle: 1°)
Measuring instruments: same as above
Volume of water drop: 4.0 μl

Average surface roughness (Ra): 410 nm
Measuring instrument: Scanning type probe microscope (SPI3800N/SPA400) produced by SII NanoTechnology Inc.
Measurement mode: AFM
Scanning area: 10 μm×10 μm

Surface structure: A scanning electron microscope image of a film surface is shown in FIG. 21.
Measuring instrument: KEYENCE Real Surface View microscope VE-9800
Acceleration voltage: 20 kV

Measuring instruments and measurement conditions are as described in Example 1.

### [Hydrophilic Portion]

Water contact angle: 32°
Volume of water drop: 1.0 μl

Average surface roughness (Ra): 4.5 nm
Measuring instrument and measurement conditions: same as above (instrument (I))

Surface structure: A scanning electron microscope image of a film surface is shown in FIG. 22.
Measuring instruments: same as above
Acceleration voltage: 20 kV

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 25

### [Step α]

### [Preparation of Substrate]

A substrate [S-2] was prepared as in Example 2.

### [Preparation of Superhydrophobic Film]

A superhydrophobic film [SH-25] having a thickness of 19 μm was obtained on a substrate as in Example 24 except that [S-2] was used as the substrate instead of [S-1].

### [Analysis of Superhydrophobic Film]

Water contact angle: 161° (sliding angle: 1°)

Measuring instruments and measurement conditions are as described in Example 1.

It was confirmed from the above described results that a superhydrophobic polymer film was formed on a methacrylic substrate.

### [Step β]

### [Preparation of Superhydrophobic/Hydrophilic Patterned Film]

A superhydrophobic/hydrophilic patterned film [SHL-2] was prepared as in Example 24 except that the superhydrophobic film [SH-25] on the substrate [S-2] was used instead of the superhydrophobic film [SH-24] on the substrate [S-1].

### [Analysis of Superhydrophobic/Hydrophilic Patterned Film]

### [Superhydrophobic Portion]

Water contact angle: 160° (sliding angle: 1°)

Average surface roughness (Ra): 400 nm (instrument (I))

Surface structure: evaluated by using a scanning electron microscope.

Measuring instruments and measurement conditions are as described in Example 1.

### [Hydrophilic Portion]

Water contact angle: 33°

Average surface roughness (Ra): 3.8 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a methacrylic substrate.

### Example 26

### [Step α]

### [Preparation of Substrate]

A substrate [S-3] was prepared as in Example 3.

### [Preparation of Superhydrophobic Film]

A superhydrophobic film [SH-26] having a thickness of 17 μm was obtained on a substrate as in Example 24 except that [S-3] was used as the substrate instead of [S-1].

### [Analysis of Superhydrophobic Film]

Water contact angle: 158° (sliding angle: 1°)

Measuring instruments and measurement conditions are as described in Example 1.

It was confirmed from the above described results that a superhydrophobic polymer film was formed on a polyester substrate.

### [Step β]

### [Preparation of Superhydrophobic/Hydrophilic Patterned Film]

A superhydrophobic/hydrophilic patterned film [SHL-3] was prepared as in Example 24 except that the superhydrophobic film [SH-26] on the substrate [S-3] was used instead of the superhydrophobic film [SH-24] on the substrate [S-1].

### [Analysis of Superhydrophobic/Hydrophilic Patterned Film]

### [Superhydrophobic Portion]

Water contact angle: 159° (sliding angle: 1°)

Average surface roughness (Ra): 390 nm (instrument (I))

Surface structure: evaluated by using a scanning electron microscope.

Measuring instruments and measurement conditions are as described in Example 1.

### [Hydrophilic Portion]

Water contact angle: 30°

Average surface roughness (Ra): 3.1 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a polyester substrate.

### Example 27

### [Step α]

### [Preparation of Superhydrophobic Film]

A polymerizable compound [A-1] was prepared as in Example 1. Thereto, 5.23 g of methyl tetradecanoate was added and the resulting mixture was homogeneously mixed to prepare a polymerizable composition [X-27].

A superhydrophobic film [SH-27] having a thickness of 16 μm was obtained on a substrate as in Example 24 except that [X-27] was used instead of the polymerizable composition [X-24].

### [Analysis of Superhydrophobic Film]

Water contact angle: 152° (sliding angle: 2°)

Measuring instruments and measurement conditions are as described in Example 1.

It was confirmed from the above described results that a superhydrophobic polymer film was formed on a glass substrate.

### [Step β]

### [Preparation of Superhydrophobic/Hydrophilic Patterned Film]

A superhydrophobic/hydrophilic patterned film [SHL-4] was prepared as in Example 24 except that the superhydrophobic film [SH-27] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 152° (sliding angle: 2°)

Average surface roughness (Ra): 260 nm (instrument (I))

Surface structure: evaluated by using a scanning electron microscope.

Measuring instruments and measurement conditions are as described in Example 1.

### [Hydrophilic Portion]

Water contact angle: 34°

Average surface roughness (Ra): 4.0 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 28

### [Step α]

### [Preparation of Superhydrophobic Film]

A polymerizable compound [A-1] was prepared as in Example 1. Thereto, 4.65 g of isobutyl benzene and 0.52 g of polyisobutyl methacrylate (weight-average molecular weight: 300,000) produced by Aldrich were added and the resulting mixture was homogeneously mixed to prepare a polymerizable composition [X-28].

A superhydrophobic film [SH-28] having a thickness of 23 μm was obtained on a substrate as in Example 24 except that [X-28] was used instead of the polymerizable composition [X-24].

### [Analysis of Superhydrophobic Film]

Water contact angle: 161° (sliding angle: 1°)

Measuring instruments and measurement conditions are as described in Example 1.

It was confirmed from the above described results that a superhydrophobic polymer film was formed on a glass substrate.

### [Step ⊕]

### [Preparation of Superhydrophobic/Hydrophilic Patterned Film]

A superhydrophobic/hydrophilic patterned film [SHL-5] was prepared as in Example 24 except that the superhydrophobic film [SH-28] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 160° (sliding angle: 1°)

Average surface roughness (Ra): 370 nm (instrument (I))

Surface structure: evaluated by using a scanning electron microscope.

Measuring instruments and measurement conditions are as described in Example 1.

### [Hydrophilic Portion]

Water contact angle: 31°

Average surface roughness (Ra): 3.9 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 29

### [Step α]

### [Preparation of Superhydrophobic Film]

A polymerizable compound [A-1] was prepared as in Example 1. Thereto, 4.64 g of diethylene glycol dibutyl ether and 0.52 g of polyisobutyl methacrylate (weight-average molecular weight: 300,000) produced by Aldrich were added and the resulting mixture was homogeneously mixed to prepare a polymerizable composition [X-29].

A superhydrophobic film [SH-29] having a thickness of 20 μm was obtained on a substrate as in Example 24 except that [X-29] was used instead of the polymerizable composition [X-24].

### [Analysis of Superhydrophobic Film]

Water contact angle: 160° (sliding angle: 1°)

Measuring instruments and measurement conditions are as described in Example 1.

It was confirmed from the above described results that a superhydrophobic polymer film was formed on a glass substrate.

### [Step β]

### [Preparation of Superhydrophobic/Hydrophilic Patterned Film]

A superhydrophobic/hydrophilic patterned film [SHL-6] was prepared as in Example 24 except that the superhydrophobic film [SH-29] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 161° (sliding angle: 1°)

Average surface roughness (Ra): 390 nm (instrument (I))

Surface structure: evaluated by using a scanning electron microscope.

Measuring instruments and measurement conditions are as described in Example 1.

### [Hydrophilic Portion]

Water contact angle: 30°

Average surface roughness (Ra): 4.3 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 30

### [Step α]

### [Preparation of Superhydrophobic Film]

A polymerizable compound [A-1] was prepared as in Example 1. Thereto, 4.64 g of methyl decanoate and 0.52 g of polyethyl methacrylate (weight-average molecular weight: 340,000) produced by Aldrich were added and the resulting mixture was homogeneously mixed to prepare a polymerizable composition [X-30].

A superhydrophobic film [SH-30] having a thickness of 19 μm was obtained on a substrate as in Example 24 except that [X-30] was used instead of the polymerizable composition [X-24].

### [Analysis of Superhydrophobic Film]

Water contact angle: 154° (sliding angle: 1°)

Measuring instruments and measurement conditions are as described in Example 1.

It was confirmed from the above described results that a superhydrophobic polymer film was formed on a glass substrate.

### [Step β]

### [Preparation of Superhydrophobic/Hydrophilic Patterned Film]

A superhydrophobic/hydrophilic patterned film [SHL-7] was prepared as in Example 24 except that the superhydrophobic film [SH-30] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 155° (sliding angle: 1°)

Average surface roughness (Ra): 320 nm (instrument (I))

Surface structure: evaluated by using a scanning electron microscope.

Measuring instruments and measurement conditions are as described in Example 1.

### [Hydrophilic Portion]

Water contact angle: 33°

Average surface roughness (Ra): 4.7 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 31

### [Step α]

### [Preparation of Superhydrophobic Film]

A polymerizable compound [A-1] was prepared as in Example 1. Thereto, 4.64 g of methyl decanoate and 0.48 g of polystyrene (weight-average molecular weight: 280,000) produced by Aldrich were added and the resulting mixture was homogeneously mixed to prepare a polymerizable composition [X-31].

A superhydrophobic film [SH-31] having a thickness of 18 μm was obtained on a substrate as in Example 24 except that [X-31] was used instead of the polymerizable composition [X-24].

### [Analysis of Superhydrophobic Film]

Water contact angle: 150° (sliding angle: 2°)

Measuring instruments and measurement conditions are as described in Example 1.

It was confirmed from the above described results that a superhydrophobic polymer film was formed on a glass substrate.

### [Step β]

### [Preparation of Superhydrophobic/Hydrophilic Patterned Film]

A superhydrophobic/hydrophilic patterned film [SHL-8] was prepared as in Example 24 except that the superhydrophobic film [SH-31] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 152° (sliding angle: 2°)

Average surface roughness (Ra): 310 nm (instrument (I))

Surface structure: evaluated by using a scanning electron microscope.

Measuring instruments and measurement conditions are as described in Example 1.

### [Hydrophilic Portion]

Water contact angle: 34°

Average surface roughness (Ra): 2.7 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 32

### [Step α]

### [Preparation of Superhydrophobic Film]

A polymerizable compound [A-4] was prepared as in Example 4. Thereto, 4.64 g of methyl decanoate and 0.52 g of polyisobutyl methacrylate (weight-average molecular weight: 300,000) produced by Aldrich were added and the resulting mixture was homogeneously mixed to prepare a polymerizable composition [X-32].

A superhydrophobic film [SH-32] having a thickness of 20 μm was obtained on a substrate as in Example 24 except that [X-32] was used instead of the polymerizable composition [X-24].

### [Analysis of Superhydrophobic Film]

Water contact angle: 159° (sliding angle: 1°)

Measuring instruments and measurement conditions are as described in Example 1.

It was confirmed from the above described results that a superhydrophobic polymer film was formed on a glass substrate.

### [Step β]

### [Preparation of Superhydrophobic/Hydrophilic Patterned Film]

A superhydrophobic/hydrophilic patterned film [SHL-9] was prepared as in Example 24 except that the superhydrophobic film [SH-32] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 160° (sliding angle: 1°)

Average surface roughness (Ra): 290 nm (instrument (I))

Surface structure: evaluated by using a scanning electron microscope.

Measuring instruments and measurement conditions are as described in Example 1.

### [Hydrophilic Portion]

Water contact angle: 32°

Average surface roughness (Ra): 3.2 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 33

### [Step α]

### [Preparation of Superhydrophobic Film]

A polymerizable compound [A-5] was prepared as in Example 5. Thereto, 4.64 g of methyl decanoate and 0.52 g of polyisobutyl methacrylate (weight-average molecular weight: 300,000) produced by Aldrich were added and the resulting mixture was homogeneously mixed to prepare a polymerizable composition [X-33].

A superhydrophobic film [SH-33] having a thickness of 26 μm was obtained on a substrate as in Example 24 except that [X-33] was used instead of the polymerizable composition [X-24].

### [Analysis of Superhydrophobic Film]

Water contact angle: 157° (sliding angle: 1°)

Measuring instruments and measurement conditions are as described in Example 1.

It was confirmed from the above described results that a superhydrophobic polymer film was formed on a glass substrate.

### [Step β]

### [Preparation of Superhydrophobic/Hydrophilic Patterned Film]

A superhydrophobic/hydrophilic patterned film [SHL-10] was prepared as in Example 24 except that the superhydrophobic film [SH-33] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 158° (sliding angle: 1°)

Average surface roughness (Ra): 360 nm (instrument (I))

Surface structure: evaluated by using a scanning electron microscope.

Measuring instruments and measurement conditions are as described in Example 1.

### [Hydrophilic Portion]

Water contact angle: 32°

Average surface roughness (Ra): 3.4 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 34

### [Step α]

### [Preparation of Superhydrophobic Film]

A polymerizable composition [X-24] was prepared as in Example 24. Thereto, 50.5 g of ethyl acetate was added and the resulting mixture was homogeneously mixed to prepare a polymerizable composition [X-34].

The polymerizable composition [X-34] was applied to the surface-treated substrate [S-1] as in Example 1 by using a spin coater under conditions of 2000 rpm and 180 seconds. The coating film was polymerized as in Example 24 and washed to form a superhydrophobic film [SH-34] having a thickness of 0.7 μm on a substrate.

### [Analysis of Superhydrophobic Film]

Water contact angle: 152° (sliding angle: 2°)

Measuring instruments and measurement conditions are as described in Example 1.

It was confirmed from the above described results that a superhydrophobic polymer film was formed on a glass substrate.

### [Step β]

### [Preparation of Superhydrophobic/Hydrophilic Patterned Film]

A superhydrophobic/hydrophilic patterned film [SHL-11] was prepared as in Example 24 except that the superhydrophobic film [SH-34] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 152° (sliding angle: 2°)

Average surface roughness (Ra): 52 nm (instrument (I))

Surface structure: evaluated by using a scanning electron microscope.

Measuring instruments and measurement conditions are as described in Example 1.

### [Hydrophilic Portion]

Water contact angle: 30°

Average surface roughness (Ra): 3.5 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 35

### [Step α]

### [Preparation of Superhydrophobic Film]

A polymerizable composition [X-24] was prepared as in Example 24. Thereto, 9.23 g of hexane was added and the resulting mixture was homogeneously mixed to prepare a polymerizable composition [X-35].

The polymerizable composition [X-35] was applied to the surface-treated substrate [S-1] as in Example 1 by using a spin coater under conditions of 2000 rpm and 180 seconds. The coating film was polymerized as in Example 24 and washed to form a superhydrophobic film [SH-35] having a thickness of 0.8 μm on a substrate.

### [Analysis of Superhydrophobic Film]

Water contact angle: 151° (sliding angle: 2°)

Measuring instruments and measurement conditions are as described in Example 1.

It was confirmed from the above described results that a superhydrophobic polymer film was formed on a glass substrate.

### [Step β]

### [Preparation of Superhydrophobic/Hydrophilic Patterned Film]

A superhydrophobic/hydrophilic patterned film [SHL-12] was prepared as in Example 24 except that the superhydrophobic film [SH-35] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 152° (sliding angle: 2°)

Average surface roughness (Ra): 47 nm (instrument (I))

Surface structure: evaluated by using a scanning electron microscope.

Measuring instruments and measurement conditions are as described in Example 1.

### [Hydrophilic Portion]

Water contact angle: 29°

Average surface roughness (Ra): 4.1 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 36

### [Step α]

### [Preparation of Superhydrophobic Film]

A superhydrophobic film [SH-24] having a thickness of 18 μm was formed on a substrate [S-1] as in Example 24.

### [Step β]

### [Preparation of Superhydrophobic/Hydrophilic Patterned Film]

A polymerizable composition [Y-2] was prepared by homogeneously mixing 3.00 g of “ARONIX M-215” described above, 2.00 g of N,N-dimethylacrylamide “049-19185” produced by Wako Pure Chemical Industries, Ltd., and 0.01 g of “IRGACURE 184” as the photopolymerization initiator.

A superhydrophobic/hydrophilic patterned film [SHL-13] was prepared on the superhydrophobic film [SH-24] on the substrate [S-1] as in Example 24 except that [Y-2] was used instead of the polymerizable composition [Y-1].

### [Analysis of Superhydrophobic/Hydrophilic Patterned Film]

### [Superhydrophobic Portion]

Water contact angle: 160° (sliding angle: 1°)

Average surface roughness (Ra): 420 nm (instrument (I))

Surface structure: evaluated by using a scanning electron microscope.

Measuring instruments and measurement conditions are as described in Example 1.

### [Hydrophilic Portion]

Water contact angle: 21°

Average surface roughness (Ra): 3.8 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 37

### [Step α]

### [Preparation of Superhydrophobic Film]

A superhydrophobic film [SH-24] having a thickness of 18 μm was formed on a substrate [S-1] as in Example 24.

### [Step β]

### [Preparation of Superhydrophobic/Hydrophilic Patterned Film]

A polymerizable composition [Y-3] was prepared by homogeneously mixing 3.25 g of “ARONIX M-215” described above, 1.25 g of N-isopropylacrylamide “099-03695” produced by Wako Pure Chemical Industries, Ltd., 0.50 g 2-hydroxyethyl acrylate “Light Ester HOA” produced by KYOEISHA CHEMICAL Co., Ltd., and 0.01 g of “IRGACURE 184” as the photopolymerization initiator.

A superhydrophobic/hydrophilic patterned film [SHL-14] was prepared on the superhydrophobic film [SH-24] on the substrate [S-1] as in Example 24 except that [Y-3] was used instead of the polymerizable composition [Y-1].

### [Analysis of Superhydrophobic/Hydrophilic Patterned Film]

### [Superhydrophobic Portion]

Water contact angle: 161° (sliding angle: 1°)

Average surface roughness (Ra): 410 nm (instrument (I))

Surface structure: evaluated by using a scanning electron microscope.

Measuring instruments and measurement conditions are as described in Example 1.

### [Hydrophilic Portion]

Water contact angle: 30°

Average surface roughness (Ra): 4.4 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 38

### [Step α]

### [Preparation of Superhydrophobic Film]

A superhydrophobic film [SH-24] having a thickness of 18 μm was formed on a substrate [S-24] as in Example 1.

### [Step β]

### [Preparation of Superhydrophobic/Hydrophilic Patterned Film]

A polymerizable composition [Y-4] was prepared by homogeneously mixing 3.25 g of polyethylene glycol #600 diacrylate “NK Ester A-600” produced by Shin-Nakamura Chemical Co., Ltd., 1.25 g of “099-03695” described above, 0.50 g of “Light Ester HOA” described above, and 0.01 g of “IRGACURE 184” as the photopolymerization initiator.

A superhydrophobic/hydrophilic patterned film [SHL-15] was prepared on the superhydrophobic film [SH-24] on the substrate [S-1] as in Example 24 except that [Y-4] was used instead of the polymerizable composition [Y-1].

### [Analysis of Superhydrophobic/Hydrophilic Patterned Film]

### [Superhydrophobic Portion]

Water contact angle: 160° (sliding angle: 1°)

Average surface roughness (Ra): 390 nm (instrument (I))

Surface structure: evaluated by using a scanning electron microscope.

Measuring instruments and measurement conditions are as described in Example 1.

### [Hydrophilic Portion]

Water contact angle: 24°

Average surface roughness (Ra): 3.3 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 39

### [Step α]

### [Preparation of Superhydrophobic Film]

A superhydrophobic film [SH-24] having a thickness of 18 μm was formed on a substrate [S-1] as in Example 24.

### [Step β]

### [Preparation of Superhydrophobic/Hydrophilic Patterned Film]

A polymerizable composition [Y-5] was prepared by homogeneously mixing 3.00 g of “ARONIX M-215” described above, 1.00 g of “NEW FRONTIER N-177E” described above, 1.00 g bis(polylxyethylene polycyclic phenyl ether) methacrylate sulfuric acid ester salt “Antox MS-60” produced by Nippon Nyukazai Co., Ltd., and 0.01 g of “IRGACURE 184” as the photopolymerization initiator.

A superhydrophobic/hydrophilic patterned film [SHL-16] was prepared on the superhydrophobic film [SH-24] on the substrate [S-1] as in Example 24 except that [Y-5] was used instead of the polymerizable composition [Y-1].

### [Analysis of Superhydrophobic/Hydrophilic Patterned Film]

### [Superhydrophobic Portion]

Water contact angle: 162° (sliding angle: 1°)

Average surface roughness (Ra): 430 nm (instrument (I))

Surface structure: evaluated by using a scanning electron microscope.

Measuring instruments and measurement conditions are as described in Example 1.

### [Hydrophilic Portion]

Water contact angle: 7°

Average surface roughness (Ra): 3.6 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 40

### [Step α]

### [Preparation of Superhydrophobic Film]

A superhydrophobic film [SH-24] having a thickness of 18 μm was formed on a substrate [S-24] as in Example 1.

### [Step β]

### [Preparation of Superhydrophobic/Hydrophilic Patterned Film]

A polymerizable composition [Y-6] was prepared by homogeneously mixing 3.00 g of “ARONIX M-215” described above, 2.00 g of “Antox MS-60” described above, and 0.01 g of “IRGACURE 184” as the photopolymerization initiator.

A superhydrophobic/hydrophilic patterned film [SHL-17] was prepared on the superhydrophobic film [SH-24] on the substrate [S-1] as in Example 24 except that [Y-6] was used instead of the polymerizable composition [Y-1].

### [Analysis of Superhydrophobic/Hydrophilic Patterned Film]

### [Superhydrophobic Portion]

Water contact angle: 160° (sliding angle: 1°)

Average surface roughness (Ra): 400 nm (instrument (I))

Surface structure: evaluated by using a scanning electron microscope.

Measuring instruments and measurement conditions are as described in Example 1.

### [Hydrophilic Portion]

Water contact angle: 10°

Average surface roughness (Ra): 4.9 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 41

### [Step α]

### [Preparation of Superhydrophobic Film]

A superhydrophobic film [SH-24] having a thickness of 18 μm was formed on a substrate [S-24] as in Example 1.

### [Step β]

### [Preparation of Superhydrophobic/Hydrophilic Patterned Film]

A polymerizable composition [Y-7] was prepared by homogeneously mixing 1.00 g of 2-sodium sulfoethyl methacrylate “Antox MS-2N” produced by Nippon Nyukazai Co., Ltd., 2.00 g of water, 1.20 g of 2-propanol, and 0.01 g of “IRGACURE 184” as the photopolymerization initiator.

The polymerizable composition [Y-7] was applied to the superhydrophobic film [SH-24] on the substrate [S-1] dropwise using a dropper. Then portions to remain superhydrophobic were photo-masked, and ultraviolet light having an UV intensity of 40 mW/cm² at 365 nm was applied for 3 minutes using “lamp 1” at room temperature in a nitrogen stream. Then washing was conducted with a water/2-propanol mixed solution (mass ratio: 5/3) to remove the unreacted composition [Y-7]. As a result, a superhydrophobic/hydrophilic patterned film [SHL-18] was prepared.

### [Analysis of Superhydrophobic/Hydrophilic Patterned Film]

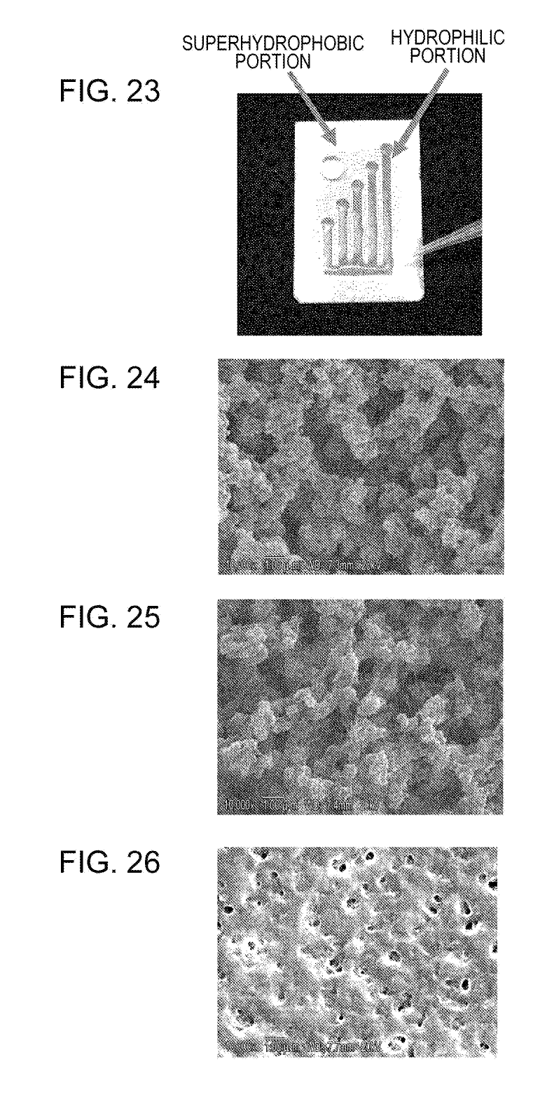

Appearance: An image of the appearance of the film is shown in FIG. 23.

### [Superhydrophobic Portion]

Water contact angle: 160° (sliding angle: 1°)

Average surface roughness (Ra): 420 nm (instrument (I))

Surface structure: A scanning electron microscope image of a film surface is shown in FIG. 5.

Measuring instruments and measurement conditions are as described in Example 1.

### [Hydrophilic Portion]

Water contact angle: 0°

Average surface roughness (Ra): 400 nm (instrument (I))

Surface structure: A scanning electron microscope image of a film surface is shown in FIG. 25.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 42

### [Step α]

### [Preparation of Superhydrophobic Film]

A superhydrophobic film [SH-33] having a thickness of 26 μm was formed on a substrate [S-1] as in Example 33.

### [Step β]

### [Preparation of Superhydrophobic/Hydrophilic Patterned Film]

A superhydrophobic/hydrophilic patterned film [SHL-19] was prepared by using the polymerizable composition [Y-7] as in Example 41 except that the superhydrophobic film [SH-33] on the substrate [S-1] was used instead of the superhydrophobic film [SH-24] on the substrate [S-1].

### [Analysis of Superhydrophobic/Hydrophilic Patterned Film]

### [Superhydrophobic Portion]

Water contact angle: 158° (sliding angle: 1°)

Average surface roughness (Ra): 350 nm (instrument (I))

Surface structure: evaluated by using a scanning electron microscope.

Measuring instruments and measurement conditions are as described in Example 1.

### [Hydrophilic Portion]

Water contact angle: 0°

Average surface roughness (Ra): 360 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 43

### [Step α]

### [Preparation of Superhydrophobic Film]

A superhydrophobic film [SH-24] having a thickness of 18 μm was formed on a substrate [S-24] as in Example 1.

### [Step β]

### [Preparation of Superhydrophobic/Hydrophilic Patterned Film]

A polymerizable composition [Y-8] was prepared by homogeneously mixing 1.00 g of dimethylaminoethyl methacrylate quaternarized “Light Ester DQ-100” produced by KYOEISHA CHEMICAL Co., Ltd., 2.00 g of water, 1.20 g of 2-propanol, and 0.01 g of “IRGACURE 184” as the photopolymerization initiator.

A superhydrophobic/hydrophilic patterned film [SHL-20] was formed on the superhydrophobic film [SH-24] on the substrate [S-1] as in Example 41 except that [Y-8] was used instead of the polymerizable composition [Y-7].

### [Analysis of Superhydrophobic/Hydrophilic Patterned Film]

### [Superhydrophobic Portion]

Water contact angle: 161° (sliding angle: 1°)

Average surface roughness (Ra): 390 nm (instrument (I))

Surface structure: evaluated by using a scanning electron microscope.

Measuring instruments and measurement conditions are as described in Example 1.

### [Hydrophilic Portion]

Water contact angle: 0°

Average surface roughness (Ra): 380 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 44

### [Step α]

### [Preparation of Superhydrophobic Film]

A superhydrophobic film [SH-33] having a thickness of 26 μm was formed on a substrate [S-1] as in Example 33.

### [Step β]

### [Preparation of Superhydrophobic/Hydrophilic Patterned Film]

A superhydrophobic/hydrophilic patterned film [SHL-21] was formed on the superhydrophobic film [SH-33] on the substrate [S-1] as in Example 42 except that [Y-8] was used instead of the polymerizable composition [Y-7].

### [Analysis of Superhydrophobic/Hydrophilic Patterned Film]

### [Superhydrophobic Portion]

Water contact angle: 159° (sliding angle: 1°)

Average surface roughness (Ra): 350 nm (instrument (I))

Surface structure: evaluated by using a scanning electron microscope.

Measuring instruments and measurement conditions are as described in Example 1.

### [Hydrophilic Portion]

Water contact angle: 0°

Average surface roughness (Ra): 350 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 45

### [Step β]

### [Preparation of Hydrophilic Film]

A polymerizable composition [Y-1] was prepared as in Example 24. The polymerizable composition [Y-1] was applied to the substrate [S-1] prepared as in Example 24 by using a spin coater under conditions of 3000 rpm and 25 seconds. The lamp 1 was used to irradiate the polymerizable composition [Y-1] with UV light having an UV intensity of 40 mW/cm² at 365 nm for 1 minute at room temperature in a nitrogen stream to polymerize the composition. As a result, a hydrophilic film [PH-1] having a thickness of 25 μm was formed on the substrate.

### [Analysis of Hydrophilic Film]

Water contact angle: 25°

Surface structure: evaluated by using a scanning electron microscope.

Measuring instruments and measurement conditions are as described in Example 24.

### [Step α]

### [Preparation of Superhydrophobic/Hydrophilic Patterned Film]

A polymerizable composition [X-24] was prepared as in Example 24. The polymerizable composition [X-24] was applied to the superhydrophobic film [PH-1] on the substrate [S-1] using a spin coater under conditions of 1000 rpm and 10 seconds. Then portions to remain hydrophilic were photo-masked, and ultraviolet light having an UV intensity of 50 mW/cm² at 365 nm was applied for 185 seconds using the lamp 2. Then washing was conducted with ethanol to remove the unreacted composition [X-24]. As a result, a superhydrophobic/hydrophilic patterned film [SHL-22] was prepared.

### [Analysis of Superhydrophobic/Hydrophilic Patterned Film]

### [Superhydrophobic Portion]

Water contact angle: 160° (sliding angle: 1°)

Average surface roughness (Ra): 380 nm (instrument (I))

Surface structure: evaluated by using a scanning electron microscope.

Measuring instruments and measurement conditions are as described in Example 1.

### [Hydrophilic Portion]

Water contact angle: 29°

Average surface roughness (Ra): 2.2 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 46

### [Step β]

### [Preparation of Hydrophilic Film]

A polymerizable composition [Y-7] was prepared as in Example 41. The polymerizable composition [Y-7] was applied to the substrate [S-1] prepared as in Example 24 by using a spin coater under conditions of 1000 rpm and 10 seconds. The lamp 1 was used to irradiate the polymerizable composition [Y-7] with UV light having an UV intensity of 40 mW/cm² at 365 nm for 3 minutes at room temperature in a nitrogen stream to polymerize the composition. As a result, a hydrophilic film [PH-2] having a thickness of 5 μm was formed on the substrate.

### [Analysis of Hydrophilic Film]

Water contact angle: 5°

Surface structure: evaluated by using a scanning electron microscope.

Measuring instruments and measurement conditions are as described in Example 1.

### [Step α]

### [Preparation of Superhydrophobic/Hydrophilic Patterned Film]

A polymerizable composition [X-24] was prepared as in Example 24. The polymerizable composition [X-24] was applied to the superhydrophobic film [PH-2] on the substrate [S-1] using a spin coater under conditions of 1000 rpm and 10 seconds. Then portions to remain hydrophilic were photo-masked, and ultraviolet light having an UV intensity of 50 mW/cm² at 365 nm was applied for 185 seconds using the lamp 2. Then washing was conducted with ethanol to remove the unreacted composition [X-24]. As a result, a superhydrophobic/hydrophilic patterned film [SHL-23] was prepared.

### [Analysis of Superhydrophobic/Hydrophilic Patterned Film]

### [Superhydrophobic Portion]

Water contact angle: 162° (sliding angle: 1°)

Average surface roughness (Ra): 410 nm (instrument (I))

Surface structure: evaluated by using a scanning electron microscope.

Measuring instruments and measurement conditions are as described in Example 1.

### [Hydrophilic Portion]

Water contact angle: 5°

Average surface roughness (Ra): 3.9 nm (instrument (I))

Surface structure: evaluated by using a scanning electron microscope.

Measuring instruments and measurement conditions are as described in Example 1.

It was confirmed from the above described results that a superhydrophobic/hydrophilic patterned film having a surface in which a superhydrophobic portion and a hydrophilic portion coexisted was formed on a glass substrate.

### Example 47

### [Preparation of Substrate]

A substrate [S-1] was prepared as in Example 1.

### [Preparation of Superhydrophobic Film]

A superhydrophobic film [SH-1] having a thickness of 20 μm was formed on a substrate [S-1] as in Example 1 by using the film-forming composition [X-1].

Next, the step of forming a superhydrophobic film by using the film-forming composition [X-1] as in Example 1 was repeated 4 times on the superhydrophobic film [SH-1] to obtain a superhydrophobic film [SH-47] having a thickness of 52 μm. [Analysis of Superhydrophobic Film]

Water contact angle: 158° (sliding angle: 2°)

Surface structure: evaluated by using a scanning electron microscope.

(Instrument (I)) Average surface roughness (Ra): 200 nm

(Instrument (II)) Average surface roughness (Ra): 190 nm

Measuring instruments and measurement conditions are as described in Example 1.

Wear resistance: 200 cycles of testing was conducted at a load of 10 g using BEMCOT produced by Asahi Kasei Corporation as a wear resistance material. Water contact angle: 150° (sliding angle: 8°)

It was confirmed from the results described above that a superhydrophobic film having high wear resistance was formed by repeating the production process for the superhydrophobic film.

### Example 48

### [Preparation of Substrate]

A substrate [S-1] was prepared as in Example 1.

### [Preparation of Superhydrophobic Film]

A superhydrophobic film [SH-6] having a thickness of 18 μm was formed on the substrate [S-1] as in Example 6 by using the film-forming composition [X-6].

Next, the step of forming a superhydrophobic film by using the film-forming composition [X-6] as in Example 6 was repeated 4 times on the superhydrophobic film [SH-6] to obtain a superhydrophobic film [SH-48] having a thickness of 55 μm.

### [Analysis of Superhydrophobic Film]

Water contact angle: 160° (sliding angle: 3°)

Surface structure: evaluated by using a scanning electron microscope.

(Instrument (I)) Average surface roughness (Ra): 250 nm

(Instrument (II)) Average surface roughness (Ra): 240 nm

Measuring instruments and measurement conditions are as described in Example 1.

Wear resistance: 200 cycles of testing was conducted at a load of 10 g using BEMCOT produced by Asahi Kasei Corporation as a wear resistance material. Water contact angle: 153° (sliding angle: 10°)

It was confirmed from the results described above that a superhydrophobic film having high wear resistance was formed by repeating the production process for the superhydrophobic film.

### Example 49

### [Step α]

### [Preparation of Substrate]

A substrate [S-1] was prepared as in Example 1.

### [Preparation of Superhydrophobic Film]

A superhydrophobic film [SH-24] having a thickness of 18 μm was formed on the substrate [S-1] as in Example 24 by using the film-forming composition [X-24].

Next, the step of forming a superhydrophobic film by using the film-forming composition [X-24] as in Example 24 was repeated 4 times on the superhydrophobic film [SH-24] to obtain a superhydrophobic film [SH-49] having a thickness of 54 μm.

### [Analysis of Superhydrophobic Film]

Water contact angle: 157° (sliding angle: 2°)

Measuring instruments and measurement conditions are as described in Example 1.

It was confirmed from the above described results that a superhydrophobic film was formed on a glass substrate.

### [Step β]

### [Preparation of Superhydrophobic/Hydrophilic Patterned Film]

A superhydrophobic/hydrophilic patterned film [SHL-49] was formed by using the polymerizable composition [Y-7] as in Example 41.

### [Analysis Of Superhydrophobic/Hydrophilic Patterned Film]

### [Superhydrophobic Portion]

Water contact angle: 157° (sliding angle: 3°)

Average surface roughness (Ra): 490 nm (instrument (I))

Surface structure: evaluated by using a scanning electron microscope.

Measuring instruments and measurement conditions are as described in Example 1.

Wear resistance: 200 cycles of testing was conducted at a load of 10 g using BEMCOT produced by Asahi Kasei Corporation as a wear resistance material. Water contact angle: 151° (sliding angle: 10°)

### [Hydrophilic Portion]

Water contact angle: 0°

Average surface roughness (Ra): 480 nm (instrument (I))

Surface structure: evaluated by using a scanning electron microscope.

Measuring instruments and measurement conditions are as described in Example 1.

It was confirmed from the results described above that a superhydrophobic/hydrophilic patterned film having a superhydrophobic portion having high wear resistance was formed by repeating the production process for the superhydrophobic film.

### Example 50

### [Preparation of Superhydrophobic Film]

A film-forming composition [X-1] was prepared as in Example 1. Thereto, 51.5 g of ethyl acetate was added and the resulting mixture was homogeneously mixed to prepare a film-forming composition [X-50].

The film-forming composition [X-50] was applied to the surface-treated substrate [S-1] as in Example 1 by using a spin coater under conditions of 2000 rpm and 180 seconds. The coating film was polymerized as in Example 1 and washed to form a superhydrophobic film [SH-50] having a thickness of 0.5 μm on a substrate.

### [Analysis of Superhydrophobic Film]

Water contact angle: 150° (sliding angle: 5°)

Surface structure: evaluated by using a scanning electron microscope.

(Instrument (I)) Average surface roughness (Ra): 45 nm

(Instrument (II)) Average surface roughness (Ra): 32 nm

Visible light transmittance: 95.0% (wavelength: 540 nm), 98.2% (wavelength: 600 nm)

Measuring instruments and measurement conditions are as described in Example 1 and Example 18.

It was confirmed from the above described results that a superhydrophobic polymer film having high transparency and fine irregularities on the surface was formed on a glass substrate.

### Example 51

### [Preparation of Superhydrophobic Film]

A film-forming composition [X-1] was prepared as in Example 1. Thereto, 9.50 g of hexane was added and the resulting mixture was homogeneously mixed to prepare a film-forming composition [X-51].

The film-forming composition [X-51] was applied to the surface-treated substrate [S-1] as in Example 1 by using a spin coater under conditions of 2000 rpm and 180 seconds. The coating film was polymerized as in Example 1 and washed to form a superhydrophobic film [SH-51] having a thickness of 0.5 μm on a substrate.

### [Analysis of Superhydrophobic Film]

Water contact angle: 151° (sliding angle: 4°)

Surface structure: evaluated by using a scanning electron microscope.

(Instrument (I)) Average surface roughness (Ra): 47 nm

(Instrument (II)) Average surface roughness (Ra): 36 nm

Visible light transmittance: 95.3% (wavelength: 540 nm), 98.2% (wavelength: 600 nm)

Measuring instruments and measurement conditions are as described in Example 1 and Example 18.

It was confirmed from the above described results that a superhydrophobic polymer film having high transparency and fine irregularities on the surface was formed on a glass substrate.

### Example 52

### [Preparation of Superhydrophobic Film]

A polymerizable composition [A-52] was prepared by homogeneously mixing 5.4 g of urethane acrylate oligomer “UNIDIC S9-414” produced by DIC Corporation, 3.6 g of tripropylene glycol diacrylate, and 0.18 g of “IRGACURE 184” as the photopolymerization initiator. Thereto, 9.2 g of methyl hexadecanoate was added and the resulting mixture was homogeneously mixed to prepare a film-forming composition [X-52].

A superhydrophobic film [SH-52] having a thickness of 25 μm was obtained on a substrate as in Example 1 except that [X-52] was used instead of the film-forming composition [X-1].

### [Analysis of Superhydrophobic Film]

Water contact angle: 151° (sliding angle: 5°)

Surface structure: evaluated by using a scanning electron microscope image.

(Instrument (I)) Average surface roughness (Ra): 240 nm

(Instrument (II)) Average surface roughness (Ra): 220 nm

Measuring instruments and measurement conditions are as described in Example 1.

It was confirmed from the above described results that a superhydrophobic polymer film having fine irregularities on the surface was formed on a glass substrate.

### Comparative Example 7

### [Preparation of Energy Ray-Cured Film]

A polymerizable compound [A-52] was prepared as in Example 52. Thereto, 14.4 g of polyethylene glycol monolaurate (degree of polymerization of the polyethylene glycol moiety: 10) produced by Tokyo Chemical Industry Co., Ltd., was mixed according to the description in PTL 2 to prepare a film-forming composition [XR-7].

Then an energy ray-cured film [R-7] having a thickness of 26 μm was obtained on a substrate as in Example 1 except that [XR-7] was used instead of the film-forming composition [X-1].

### [Analysis of Energy Ray-Cured Film]

Water contact angle: 67°

Surface structure: evaluated by using a scanning electron microscope.

(Instrument (I)) Average surface roughness (Ra): 30 nm

Surface structure: A scanning electron microscope image of a film surface is shown in FIG. 26.

Measuring instruments and measurement conditions are as described in Example 1.

As described above, the energy ray-cured film prepared from a film-forming composition prepared according to the description of PTL 2 did not exhibit superhydrophobicity.

1. A method for producing a hydrophobic film, comprising:
a step of preparing a film-forming composition (X) by mixing a polymerizable compound (A) that can be polymerized by energy ray irradiation and a compound (B) that is compatible with the polymerizable compound (A) but incompatible with a polymer (P_{A}) of the polymerizable compound (A) and that is inactive to an energy ray;
a step of forming a layer of the film-forming composition (X); and
a step of removing the compound (B) after polymerizing the polymerizable compound (A) in the film-forming composition (X) by energy ray irradiation,
wherein the compound (B) is liquid or solid, has a molecular weight of 500 or less, and has a saturation vapor pressure of 400 Pa or less at 25° C., and
the compound (B) is at least one compound selected from the group consisting of compounds having molecular structures represented by formula (1), formula (2), formula (3), and formula (4), and alkanes having 14 to 20 carbon atoms which may be branched: 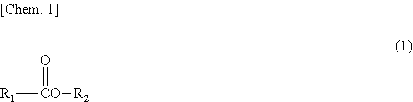
(in formula (1), R₁ represents an alkyl group having 9 to 19 carbon atoms which may be branched, and R₂ represents a methyl group or an ethyl group), 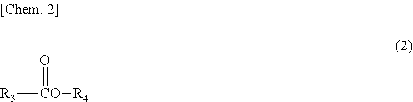
(in formula (2), R₃ represents a methyl group or an ethyl group, and R₄ represents an alkyl group having 10 to 20 carbon atoms which may be branched), 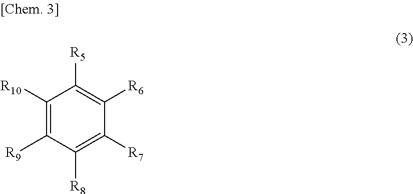
(in formula (3), R₅ to R₁₀ each independently represent a hydrogen atom or an alkyl group which may be branched and at least two of R₅ to R₁₀ are ethyl groups or at least one of R₅ to R₁₀ is an alkyl group having 3 to 8 carbon atoms which may be branched),
[Chem. 4]
R₁₁—O(CH₂)₂O(CH₂)₂O—R₁₂ (4)
(in formula (4), R₁₁ and R₁₂ each independently represent an alkyl group having 2 to 8 carbon atoms which may be branched).

2. (canceled)

3. The method for producing a hydrophobic film according to claim 1 wherein the film-forming composition (X) further contains a polymer (C) that is compatible with the polymerizable compound (A) and the compound (B) and is inactive to the energy ray.

4. The method for producing a hydrophobic film according to claim 3, wherein a liquid compound (D) having a saturation vapor pressure of 600 Pa or more at 25° C. is further contained.

5. The method for producing a hydrophobic film according to claim 4, wherein the compound (D) is at least one compound selected from the group consisting of pentane, hexane, heptane, R₁₃COOR₁₄ (where R₁₃ and R₁₄ each independently represent an alkyl group having 1 to 5 carbon atoms and the total number of carbon atoms in R₁₃ and R₁₄ is 6 or less), R₁₅COR₁₆ (where R₁₅ and R₁₆ each independently represent an alkyl group having 1 to 5 carbon atoms and the total number of carbon atoms in R₁₅ and R₁₆ is 6 or less), R₁₇OR₁₈ (where R₁₇ and R₁₈ each independently represent an alkyl group having 1 to 6 carbon atoms and the total number of carbon atoms in R₁₇ and R₁₈ is 7 or less), benzene, toluene, dichloromethane, chloroform, and carbon tetrachloride.

6. The method for producing a hydrophobic film according to claim 4 wherein the polymer (C) is an acrylic copolymer or a styrene copolymer.

7. The method for producing a hydrophobic film according to claim 4 wherein the polymer (C) has a molecular weight in a range of 10,000 to 1,000,000.

8. The method for producing a hydrophobic film according to claim 1, wherein a superhydrophobic film with which a contact angle between a film surface and water is 150° or more is produced.

9. A hydrophobic film obtained by any one of the methods according to claim 1.

10. The hydrophobic film according to claim 9, wherein an average surface roughness (Ra) is in a range of more than 30 nm and up to 1000 nm.

11. The hydrophobic film according to claim 9, wherein a transmittance for visible light having a wavelength of 600 nm is 80% or more.

12. A method for producing a patterned film having a hydrophobic region and a hydrophilic region in the same surface, comprising:
(1) step α1 including
preparing a polymerizable composition (X) containing a polymerizable compound (A) that can be polymerized by energy ray irradiation and a compound (B) that is compatible with the polymerizable compound (A) but incompatible with a polymer (P_{A}) of the polymerizable compound (A) and that is inactive to an energy ray,
forming a layer of the polymerizable composition (X), and
removing the compound (B) after polymerizing the polymerizable compound (A) in the polymerizable composition (X) by energy ray irradiation to thereby form a hydrophobic film (SH); and
(2) step β2 including
preparing a polymerizable composition (Y) containing a polymerizable compound (E) that contains a hydrophilic chemical structural unit and that can be polymerized by energy ray irradiation,
applying the polymerizable composition (Y) to part or the entirety of a surface of the hydrophobic film (SH), and
polymerizing the polymerizable compound (E) in the polymerizable composition (Y) by energy ray irradiation,
wherein
the compound (B) is liquid or solid, has a molecular weight of 500 or less, and has a saturation vapor pressure of 400 Pa or less at 25° C., and
the compound (B) is at least one compound selected from the group consisting of compounds having molecular structures represented by formula (1), formula (2), formula (3), and formula (4), and alkanes having 14 to 20 carbon atoms which may be branched, 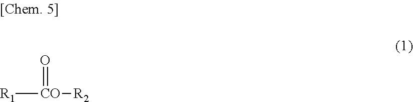
(in formula (1), R₁ represents an alkyl group having 9 to 19 carbon atoms which may be branched, and R₂ represents a methyl group or an ethyl group), 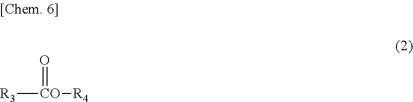
(in formula (2), R₃ represents a methyl group or an ethyl group, and R₄ represents an alkyl group having 10 to 20 carbon atoms which may be branched), 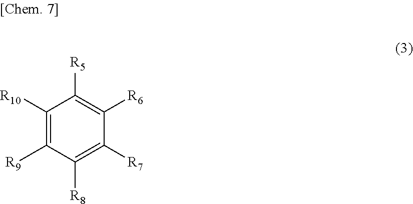
(in formula (3), R₅ to R₁₀ each independently represent a hydrogen atom or an alkyl group which may be branched and at least two of R₅ to R₁₀ are ethyl groups or at least one of R₅ to R₁₀ is an alkyl group having 3 to 8 carbon atoms which may be branched),
[Chem. 8]
R₁₁—O(CH₂)₂O(CH₂)₂O—R₁₂ (4)
(in formula (4), R₁₁ and R₁₂ each independently represent an alkyl group having 2 to 8 carbon atoms which may be branched).

13. A method for producing a patterned film having a hydrophobic region and a hydrophilic region in the same surface, comprising:
(1) step β1 including
preparing a polymerizable composition (Y) containing a polymerizable compound (E) that contains a hydrophilic chemical structural unit and that can be polymerized by energy ray irradiation,
forming a layer of the polymerizable composition (Y), and
polymerizing the polymerizable compound (E) in the polymerizable composition (Y) by energy ray irradiation to form a hydrophilic film (HP); and
(2) step α2 including
preparing a polymerizable composition (X) containing a polymerizable compound (A) that can be polymerized by energy ray irradiation and a compound (B) that is compatible with the polymerizable compound (A) but incompatible with a polymer (P_{A}) of the polymerizable compound (A) and that is inactive to an energy ray,
applying the polymerizable composition (X) to part or the entirety of a surface of the hydrophilic film (PH), and
removing the compound (B) after polymerizing the polymerizable compound (A) in the polymerizable composition (X) by energy ray irradiation,
wherein,
the compound (B) is liquid or solid, has a molecular weight of 500 or less, and has a saturation vapor pressure of 400 Pa or less at 25° C., and
the compound (B) is at least one compound selected from the group consisting of compounds having molecular structures represented by formula (1), formula (2), formula (3), and formula (4), and alkanes having 14 to 20 carbon atoms which may be branched, 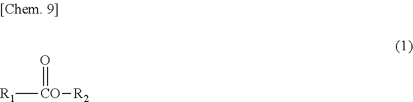
(in formula (1), R₁ represents an alkyl group having 9 to 19 carbon atoms which may be branched, and R₂ represents a methyl group or an ethyl group), 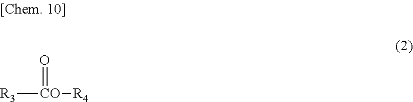
(in formula (2), R₃ represents a methyl group or an ethyl group, and R₄ represents an alkyl group having 10 to 20 carbon atoms which may be branched), 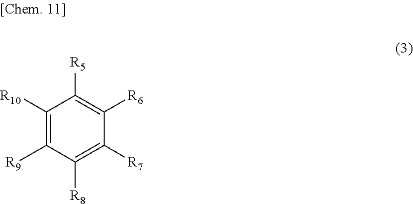
(in formula (3), R₅ to R₁₀ each independently represent a hydrogen atom or an alkyl group which may be branched and at least two of R₅ to R₁₀ are ethyl groups or at least one of R₅ to R₁₀ is an alkyl group having 3 to 8 carbon atoms which may be branched),
[Chem. 12]
R₁₁—O(CH₂)₂O(CH₂)₂O—R₁₂ (4)
(in formula (4), R₁₁ and R₁₂ each independently represent an alkyl group having 2 to 8 carbon atoms which may be branched).

14. A patterned film obtained by the method according to claim 12, the patterned film comprising a hydrophobic region and a hydrophilic region in the same surface.

15. The patterned film according to claim 14, wherein a hydrophobic portion of the film surface has a contact angle of 150° or more with water and exhibits superhydrophobicity.

16. The patterned film according to claim 14, wherein a hydrophilic portion of the film surface has a contact angle of 10° or less and exhibits superhydrophilicity.

17-19. (canceled)

20. A hydrophobic film obtained by any one of the methods according to claim 5.

21. A hydrophobic film obtained by any one of the methods according to claim 6.

22. A patterned film obtained by the method according to claim 13, the patterned film comprising a hydrophobic region and a hydrophilic region in the same surface.

23. The patterned film according to claim 22, wherein a hydrophobic portion of the film surface has a contact angle of 150° or more with water and exhibits superhydrophobicity.

24. The patterned film according to claim 22, wherein a hydrophilic portion of the film surface has a contact angle of 10° or less and exhibits superhydrophilicity.
